(19) United States
(12) Patent Application Publication
(10) Pub. No.: US 2026/0257493 A1
(43) Pub. Date: Sep. 3, 2026

(54) LABEL AFFIXING APPRATUS, PROGRAM, AND CONTROL METHOD

(71) Applicant: BROTHER KOGYO KABUSHIKI KAISHA, Nagoya (JP)

(72) Inventor: Naoto ITO, Ichinomiya (JP)

(21) Appl. No.: 19/552,078

(22) Filed: Feb. 27, 2026

(30) Foreign Application Priority Data
Feb. 28, 2025 (JP) 2025-031994
Aug. 29, 2025 (JP) 2025-143290

(51) Int. Cl. B41J 3/407; B41J 3/46; B41J 11/70; B41J 29/46; B65C 3/02; B65C 9/00; B65C 9/42; B65C 9/46

(52) U.S. Cl. CPC B41J 3/40733; B41J 3/4075; B41J 3/46; B41J 11/703; B41J 29/46; B65C 3/02; B65C 9/0006; B65C 9/42; B65C 9/46; B65C 2009/0087

(57) ABSTRACT

A label affixing apparatus includes a printing unit, a wrapping unit, and a control unit. The control unit executes a first reception process for receiving a first print instruction related to continuous printing, a printing process for printing, by the printing unit, a print image on a label in accordance with the first print instruction, a wrapping process for wrapping a printed label onto a rod-shaped member, using the wrapping unit, and a second reception process for receiving a second print instruction for reprinting. The printing process includes a first process for printing a print image on a label in accordance with the second print instruction.

### REFERENCE TO RELATED APPLICATIONS

This application claims priority from Japanese Patent Application No. 2025-031994 filed on February 28, 2025, and Japanese Patent Application No. 2025-143290 filed on August 29, 2025. The entire content of the priority applications is incorporated herein by reference.

### TECHNICAL FIELD

The present disclosure relates to a label affixing apparatus.

### BACKGROUND ART

A label affixing apparatus includes a printing section and an affixing section. The printing section performs printing on a label. The affixing section includes a rotating member that rotates and affixes the label to an object. The rotating member includes an insertion port through which the label and the object can be inserted while a part of the label is adhered to the object. The rotating member rotates while supporting the label and the object inserted through the insertion port, thereby affixing the label to the object.

### SUMMARY

The above-mentioned label affixing apparatus does not consider a method for reprinting at least some of the labels when performing continuous printing on multiple labels.

The present disclosure may describe a label affixing apparatus having reprinting capability.

One aspect of a label affixing apparatus of the present disclosure includes a printing unit, a wrapping unit, and a control unit that controls the printing unit and the wrapping unit. The control unit executes a first reception process for receiving a first print instruction related to continuous printing, a printing process for printing, by the printing unit, a print image on a label in accordance with the first print instruction, a wrapping process for wrapping a printed label onto a rod-shaped member, using the wrapping unit, and a second reception process for receiving a second print instruction for reprinting. The printing process includes a first process for printing a print image on a label in accordance with the second print instruction.

Therefore, the label affixing device has capability of reprinting.

### BRIEF DESCRIPTION OF THE DRAWINGS

FIG. 1 is a perspective view of a label affixing apparatus.

FIG. 2 is a cross-sectional view along line I-I in FIG. 1.

FIG. 3 is a diagram illustrating a hardware configuration of the label affixing apparatus.

FIG. 4 is a flowchart of a continuous printing processing.

FIG. 5 is a diagram illustrating a management buffer during continuous printing processing.

FIG. 6 is a diagram illustrating positional relationship when printing the label R of the management buffer.

FIG. 7 is a flowchart of a wrapping processing.

FIG. 8 is a flowchart of a reprint reception processing.

FIG. 9 is a flowchart of a first registration processing.

FIG. 10 is a diagram illustrating the management buffer during the first registration processing.

FIG. 11 is a flowchart of a second registration processing.

FIG. 12 is a diagram illustrating the management buffer during the second registration processing.

FIG. 13 is a diagram illustrating a reprint label management buffer during the second registration processing.

FIG. 14 is a diagram illustrating an example of notification in a modified embodiment.

FIG. 15 is a diagram illustrating the reprinted label R during a continuous printing processing.

FIG. 16 is a flowchart of a continuous printing processing.

FIG. 17 is a flowchart of a cutting processing.

FIG. 18 is a flowchart of a reprint reception processing.

FIG. 19 is a flowchart of a parameter change processing.

FIG. 20 is a flowchart of a wrapping processing.

FIG. 21 is a flowchart of a buffer processing.

FIG. 22 is a flowchart of a notification processing.

FIG. 23 is a diagram illustrating an example of notification.

### DESCRIPTION

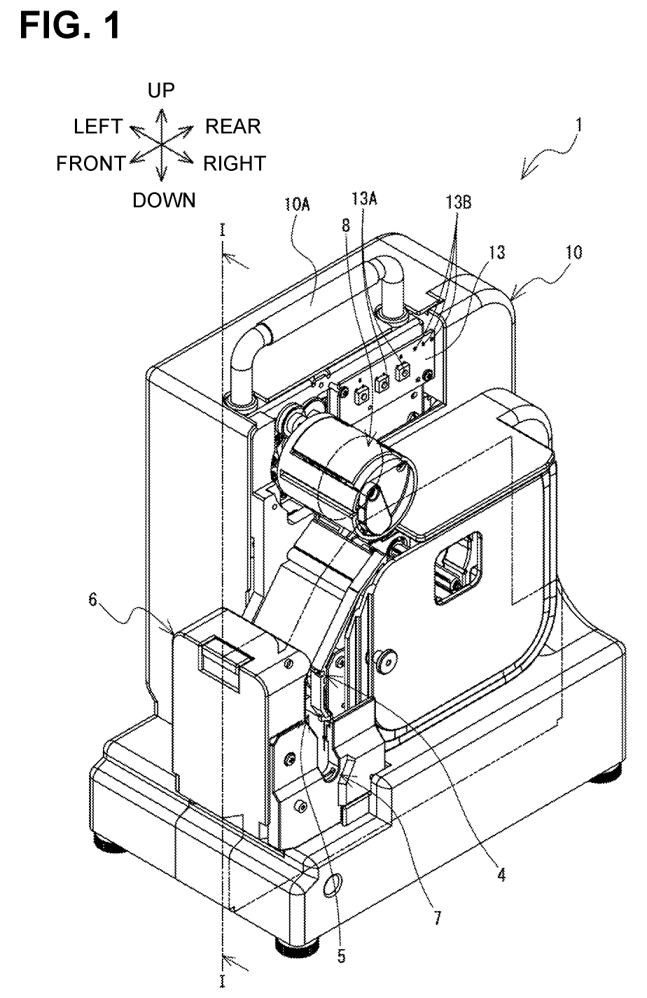

An embodiment of a label affixing apparatus 1 embodying the present disclosure will be described with reference to drawings. The drawings are used to explain technical features that may be adopted in the present disclosure. The configurations of the apparatus shown in the drawings are not intended to be limiting but are provided merely as examples for explanation. Hereinafter, the lower left, upper right, upper left, lower right, upper, and lower directions in FIG. 1 correspond to the front, rear, left, right, up, and down directions of the label affixing apparatus 1, respectively.

The label affixing apparatus 1 is configured to print an image on a printing tape, thereby generating a label R, and further configured to wrap and attach the generated label R onto a cable 19.

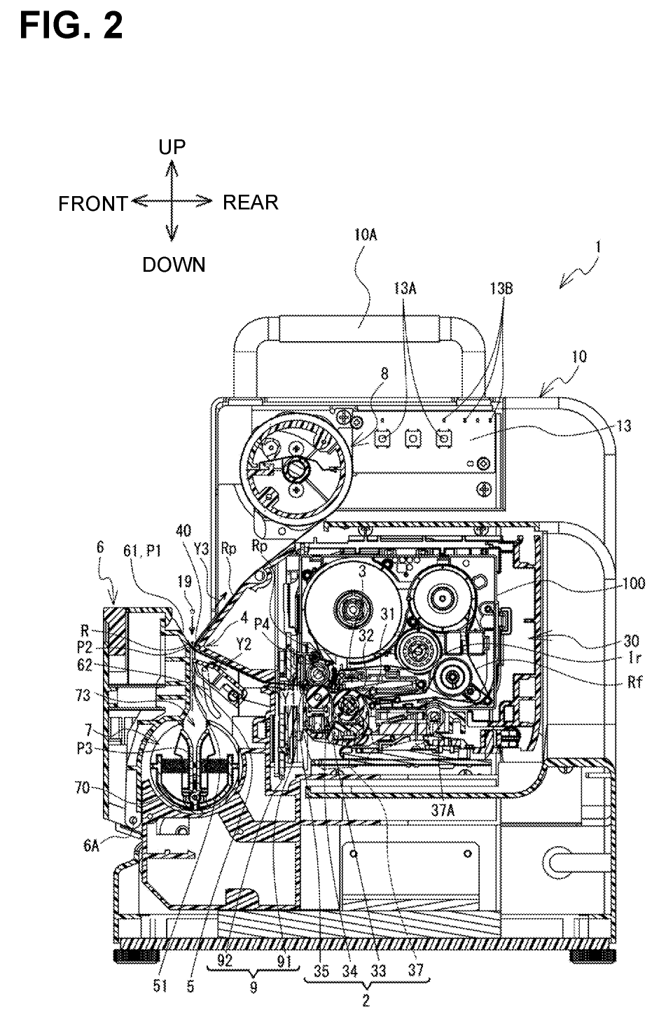

As shown in FIGS. 1 to 3, the label affixing apparatus 1 includes a box-shaped housing 10. The housing 10 has a handle 10A for carrying the label affixing apparatus 1.

The housing 10 includes an operation panel 13, a tape mounting section 30, a printing unit 3, a conveying unit 2, a cutting unit 9, a peeling part 4, an opening/closing member 6, a guide member 5, a wrapping unit 7, and a take-up unit 8.

The operation panel 13 is fixed to the upper end of the housing 10. The operation panel 13 includes an operation unit 13A and a notification unit 13B. The operation section 13A may include multiple buttons configured to receive input for the label affixing apparatus 1. The notification unit 13B may include multiple LEDs that indicate status of the label affixing apparatus 1.

The tape mounting section 30 is positioned approximately at the center in both the front-rear and vertical directions of the housing 10. The tape mounting section 30 is box-shaped with its right side open. The tape mounting section 30 is configured to accommodate a tape cassette 100. The tape cassette 100 may accommodate a laminate-type tape, a thermal-type tape, or a receptor-type tape.

In the following description, the tape cassette 100 accommodates a laminate-type tape. In the tape cassette 100, a film tape Rf, an ink ribbon Ir, and a double-sided adhesive tape with a release paper Rp attached on one side are installed. The film tape Rf, the ink ribbon Ir, and the double-sided adhesive tape with the release paper Rp are wound in the tape cassette 100.

The printing unit 3 is located below the tape mounting section 30. The printing unit 3 includes a head holder 31 and a thermal head 32.

The head holder 31 is plate-shaped extending in the front-rear and left-right directions. The thermal head 32 is supported by the head holder 31. The thermal head 32 includes multiple heating elements arranged in a single row in the left-right direction.

The thermal head 32 heats the ink ribbon Ir using multiple heating elements while the tape cassette 100 is mounted on the tape mounting section 30. As a result, ink is transferred onto the film tape Rf.

The conveying unit 2 includes a platen holder 37, a platen roller 33, a transport roller 34, and a drive roller 35.

The platen holder 37 is disposed below the head holder 31. The platen holder 37 is rotatable about a support shaft 37A.

The platen roller 33 and the transport roller 34 are rotatably supported at a distal end of the platen holder 37. The transport roller 34 is positioned on the left of the platen roller 33. The platen holder 37 is configured to swing such that the platen roller 33 contacts the thermal head 32.

The drive roller 35 is positioned above and faces the transport roller 34. The drive roller 35 is driven by a motor. The platen holder 37 is also configured to swing such that the transport roller 34 contacts the drive roller 35. The film tape Rf and the double-sided adhesive tape with the release paper Rp are transported between the drive roller 35 and the transport roller 34, thereby being laminated, that is, the double-sided adhesive tape adheres to the film tape Rf.

The cutting unit 9 is positioned downstream relative to the transport roller 34 along a transport direction Y1 of the film tape Rf and the double-sided adhesive tape with the release paper Rp. The cutting unit 9 includes a full-cutting blade 91 and a half-cutting blade 92. The full-cutting blade 91 is for fully cutting both the film tape Rf and the double-sided adhesive tape with the release paper Rp. The half-cutting blade 92 is for cutting the film tape Rf and the double-sided adhesive tape while leaving the release paper Rp uncut. The film tape Rf with the double-sided adhesive tape is referred to as a label R.

The peeling part 4 is positioned downstream relative to the cutting unit 9 along the transport direction Y1. The peeling part 4 is configured to separate the label R from the release paper Rp. The peeling part 4 includes a rotatable peeling shaft 40.

The opening and closing member 6 has a box-shaped structure. The opening and closing member 6 is rotatable about a shaft body 6A extending in the left-right direction. The opening and closing member 6 includes a support surface 61 and a pressing surface 62.

The support surface 61 is located at the upper end portion of the opening and closing member 6.

The pressing surface 62 is located at the rear end of the opening/closing member 6. The pressing surface 62 faces rearward.

The guide member 5 includes a guide surface 51 that faces the pressing surface 62.

The wrapping unit 7 is located at the bottom of the housing 10. The wrapping portion 7 includes an insertion opening 73, a rotating member 70, and a sensor S.

The wrapping unit 7 includes a substantially cylindrical rotating member 70. The rotating member 70 is configured to rotate by a motor. The sensor S is an optical sensor to detect the cable at a certain position.

The take-up unit 8 is located rearward and upward diagonally from the peeling part 4 and above the front upper corner of the tape mounting section 30. The take-up unit 8 is configured to take-up the release paper Rp around a take-up spool. The take-up unit 8 is configured to apply tension to the release paper Rp for taking-up the release paper Rp.

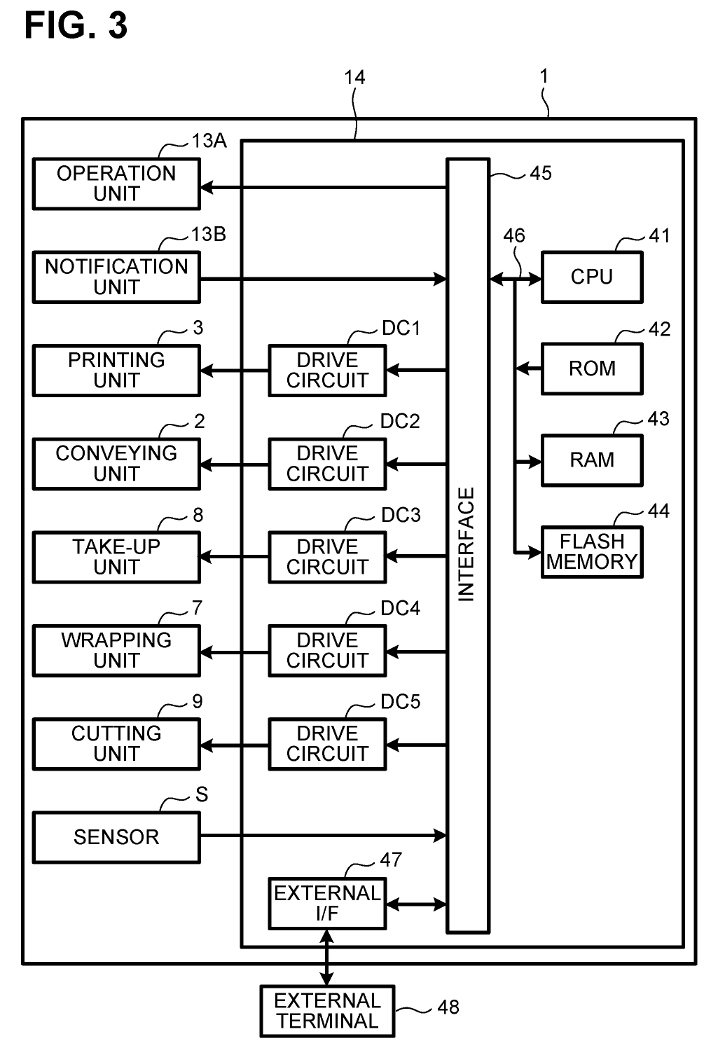

Referring to FIG. 3, a hardware configuration of the label affixing apparatus 1 will be described. A control unit 14 of the label affixing apparatus1 includes a CPU 41, a ROM 42, a RAM 43, a flash memory 44, an interface (I/F) 45, drive circuits DC1 to DC5, and an external interface (I/F) 47.

The CPU 41, the ROM 42, the RAM 43, and the flash memory 44 are connected to the I/F 45 via a bus 46. The CPU 41 centrally controls the label affixing apparatus 1. The ROM 42 stores constants for processing by the CPU 41. The RAM 43 temporarily stores various data. The flash memory 44 stores various programs to be executed by the CPU 41.

The I/F 45 is connected to the operation unit 13A, the notification unit 13B, the drive circuits DC1 to DC5, the sensor S, and the external I/F 47.

Operation unit 13A receives instructions from user input and transmits them to the CPU 41. The LED of notification unit 13B is illuminated under control of the CPU 41.

The drive circuit DC1 is configured to drive the printing unit 3. The drive circuit DC2 is configured to drive the conveying unit 2. The drive circuit DC3 is configured to drive the take-up unit 8. The drive circuit DC4 is configured to drive the wrapping unit 7. The drive circuit DC5 is configured to drive the cutting unit 9. The drive circuits DC1 to DC5 operate under control of the CPU 41.

The external interface 47 is connected to an external terminal 48 for communication. The external terminal 48 may be a general-purpose computer (PC), a tablet terminal, or a mobile device. The user edits print information using the external terminal 48. For example, the CPU 41 receives print information transmitted from the external terminal 48.

The sensor S is configured to output a detection result of the cable to the CPU 41.

The printing operation and the wrapping operation will be described. The user installs the tape cassette 100 onto the tape mounting section 30.

The user edits the print data on the external terminal 48 and transmits the print data to the label affixing apparatus 1. The print data is transferred to the CPU 41. The CPU 41 executes printing according to the print data.

When printing is executed, the drive roller 35 and the platen roller 33 rotate and transport the film tape Rf and the ink ribbon Ir from the tape cassette 100 to the thermal head 32.

The platen roller 33 presses the film tape Rf and the ink ribbon Ir against the thermal head 32. The thermal head 32 heats the ink ribbon Ir. The ink from the ink ribbon Ir is transferred onto a printing surface of the film tape Rf. Subsequently, the film tape Rf is introduced between the drive roller 35 and the transport roller 34 while the ink ribbon Ir is taken-up around a take-up spool in the tape cassette 100.

The transport roller 34 rotates together with the drive roller 35, thereby introducing the double-sided adhesive tape between the drive roller 35 and the transport roller 34. There, the transport roller 34 presses the release paper Rp toward the drive roller 35 such that the film tape Rf adheres to the release paper Rp via the double-sided adhesive. Subsequently, the film tape Rf with the adhered release paper Rp are discharged outside of the tape cassette 100.

The transport roller 34 further transports the film tape Rf with the adhered release paper Rp to the cutting unit 9. The cutting unit 9 cuts the film tape Rf and the adhesive while leaving the release paper Rp uncut, using the half-cutting blade 92. The cut film tape Rf with the adhesive is referred to as a label R. The label R is transported together with the release paper Rp in a transport direction Y2 to the peeling part 4.

At the peeling part 4, the label R with the release paper Rp is fed around the peeling shaft 40 while the release paper Rp contacts the peeling shaft 40. As the release paper Rp is pulled toward the take-up spool of the take-up unit 8, the edge of the label R is peeled off from the release paper Rp. Then, the release paper Rp is upwardly transported to the take-up spool in a conveying direction Y3 and taken-up around the take-up spool.

A front end of the label R peeled from the release paper Rp is placed on the support surface 61. The position where the label R is in this state is referred to as a stop position P1. In other words, the label R is transported by the conveying unit 2 to the stop position P1.

Next, the user grasps the cable 19, which extends in the left-right direction, with both hands and moves the cable 19 downward toward the label R on the support surface 61. When the cable 19 reaches the label R, a part of the label R adheres to the cable 19 with the adhesive on the label R.

The user moves the cable 19 further downward along the guide surface 51 toward the wrapping unit 7. The label R adhered to the cable 19 is peeled off from the release paper Rp as the cable 19 moves downward.

The user further moves the cable 19 with the adhered label R downward. During this process, the guide surface 51 and the pressing surface 62 guide the moving cable 19. The pressing surface 62 presses the cable 19 against the guide surface 51 to prevent the label end from peeling off from the cable 19.

As the cable 19 reaches the wrapping unit 7 together with the label R through the insertion opening 73, the user places the cable 19 at a support position P3. The sensor S is configured to detect that the cable 19 is at the support position P3.

While the cable 19 is at the support position P3, the control unit 14 controls the rotating member 70. As a result of the rotation of the rotating member 70, the label R is wound around the outer periphery of the cable 19. Therefore, the label R is adhered to the cable 19 by the adhesive.

As the user removes the cable 19 from the wrapping unit 7, the user can visually confirm whether the label R is properly wrapped around the cable 19.

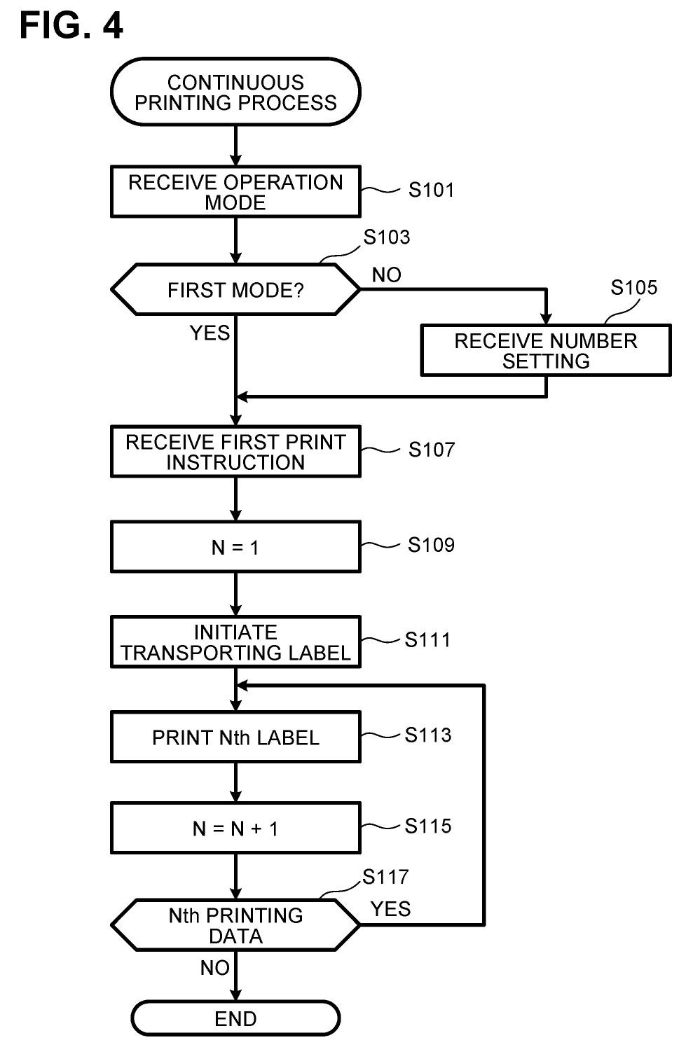

Referring to FIG. 4, continuous printing processing will be described. The CPU 41 reads and executes a program stored in the flash memory 44 to start the continuous printing process.

The CPU 41 receives a user selection of an operation mode (S101), i.e., a first mode or a second mode. The first mode is for executing a first registration processing. The second mode is for executing a second registration processing. Details of the first registration process and the second registration process will be described below.

It is determined whether the operation mode is set to the first mode (S103). When it is determined that the operation mode is the first mode (S103: YES), the CPU 41 proceeds the processing to S107.

If it is determined that the mode is not the first mode (S103: NO), that is, it is the second mode, the CPU 41 receives a number setting from a user (S105). The number setting indicates a number of labels to be made and may indicate one or more. For instance, the user may input any number with the external terminal 48. The CPU 41 then proceeds the processing to S107.

The CPU 41 receives a first print instruction (S107). The first print instruction pertains to continuous printing on multiple labels R in succession. For example, the user operates the external terminal 48 to generate the first print instruction.

The first print instruction may or may not include information indicating that the printing is continuous. Such information indicating continuous printing may, for example, relate to the number of labels R included in a single job. Furthermore, when the information indicating continuous printing is not included, it may be determined that the instruction pertains to continuous printing if printing images to be printed on the labels R are sent consecutively. In addition, when printing images to be printed on the labels R are sent consecutively, information indicating the final image may or may not be included with the last printing image.

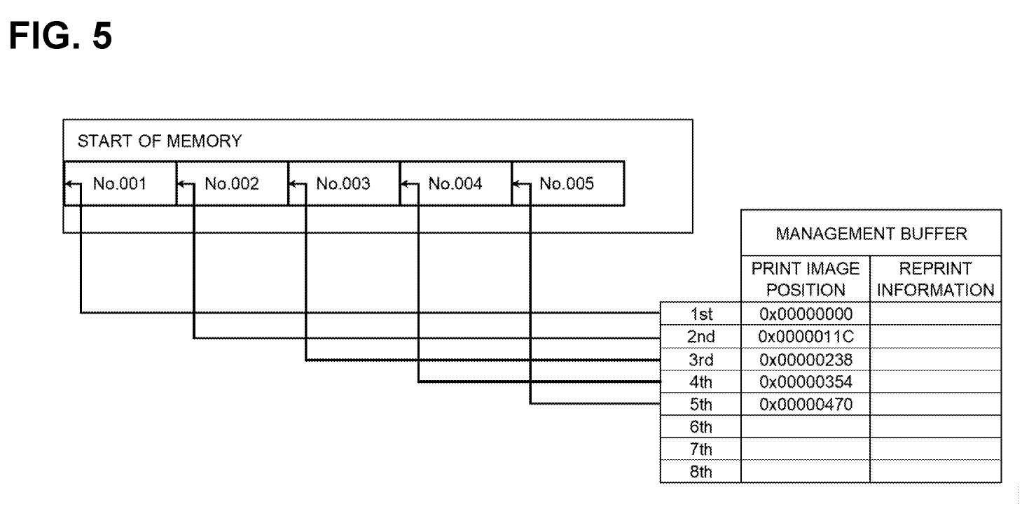

As shown in FIG. 5, for example, when continuously printing five labels R, the CPU 41 stores the print information for each label R based on the first print instruction in the RAM 43. The print information includes data such as a management buffer. The management buffer contains print image position and reprint information. The print image position indicates print order. The reprint information will be described later.

The CPU 41 sets N to 1 (S109). The CPU 41 initiates transporting the label R (S111).

The CPU 41 executes printing of the label R in the order of printed images indicated by the management buffer (S113). For example, as shown in FIG. 5, the CPU 41 prints the first label R.

Upon completion of printing, CPU 41 increments N by 1 (S115).

The CPU 41 determines whether there is printing information for the Nth label R after incrementing (S117). In other words, the CPU 41 determines whether the continuous printing according to the first print instruction has been completed.

When it is determined that there is printing information for the Nth label R (S117: YES), that is, when it is determined that continuous printing has not been completed, the CPU 41 returns the processing to S113 and executes the next printing operation.

The CPU 41 repeats the processing from S113 to S117. In other words, the CPU 41 prints, in accordance with the first print instruction, the respective print images corresponding to each of the multiple labels R.

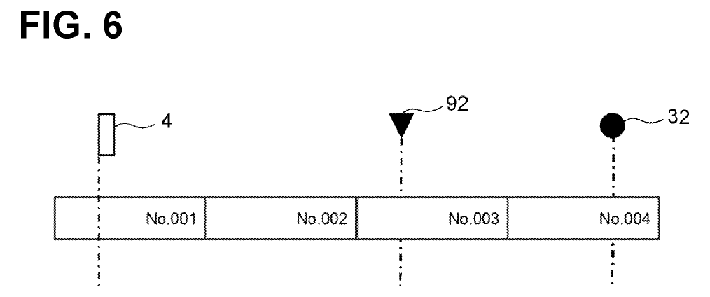

As shown in FIG. 6, for example, the label No. 1 is conveyed to the peeling part 4 after printing. At this time, the label No. 2 has already been printed. The boundary between the label No. 2 and the label No. 3 is cut by the half-cutting blade 92. The label No. 4 is currently being printed by the head. The boundary between the label No. 3 and the label No. 4 conveyed to the position of the half-cutting blade 92 is cut by the half-cutting blade 92.

On the other hand, when it is determined that there is no printing information for the Nth label R (S117: NO), that is, when it is determined that all printing has been completed, the CPU 41 terminates the continuous printing process.

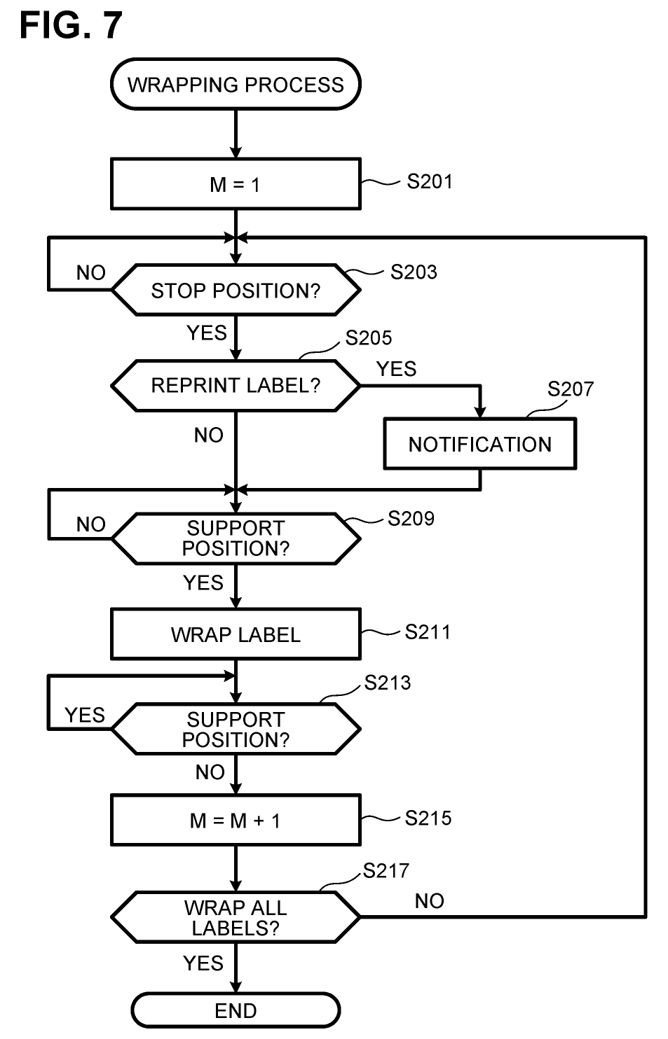

Referring to FIG. 7, a wrapping process will be described. The wrapping process is executed while the continuous printing process is being performed. The CPU 41 reads and executes a program stored in the flash memory 44. As a result, the CPU 41 initiates the wrapping process.

The CPU 41 sets M to 1 (S201).

The CPU 41 determines whether or not the M-th label R has been transported to the stop position P1 (S203). For example, the CPU 41 makes this determination based on the position of the label R currently being printed. The detection of the stop position P1 may be performed based on the rotation position of the drive motor of the conveying unit 2, or may be detected by a sensor or the like.

If it is determined that the M-th label R has not completed conveyance to the stop position P1 (S203: NO), the CPU 41 returns the processing to S203 and waits. The CPU 41 conveys the label R printed by the printing unit 3 to the stop position P1.

When it is determined that the M-th label R has been transported to the stop position P1 (S203: YES), the CPU 41 determines whether the label R transported to the stop position P1 is a reprint label (S205). The reprint label refers to the label R printed according to the second print instruction described later.

If it is determined that the label is not a reprint label (S205: NO), the CPU 41 proceeds to processing step S209.

When it is determined that the label is a reprint label (S205: YES), the CPU 41 causes the notification unit 13B to notify accordingly (S207). Therefore, the user can recognize that the label is a reprint label. Details of the notification will be described later.

The CPU 41 proceeds the processing to step S209.

The CPU 41 determines whether the cable 19 is detected at a support position P3 based on a signal from the sensor S (S209). The CPU 41 determines the detection of the cable 19 according to the output result of the sensor S.

If it is determined that the cable 19 is not detected by the sensor S at the support position P3 (S209: NO), the CPU 41 returns the processing to step S209 and waits.

Meanwhile, the user selects the cable 19 onto which the Nth label R of the continuous printing is to be wound and sets it on the wrapping unit 7. In other words, the cable 19 is positioned at the support position P3.

When the cable 19 is detected by the sensor S to be at the support position P3 (S209: YES), the CPU 41 wraps the Nth label R around the cable 19 (S211). The CPU 41 rotates the rotating member 70 to affix the label R to the cable 19.

The CPU 41 determines whether the cable 19 is at the support position P3 based on the detection result from the sensor S (S213). When it is determined that the cable 19 is at the support position P3 (S213: YES), that is, when the cable 19 has not been pulled out from the wrapping unit 7, the CPU 41 returns the processing to S213 and waits.

If it is determined that the cable 19 is not at the support position P3 (S213: NO), that is, if the cable 19 is removed from the wrapping unit 7, the CPU 41 increments M by 1 (S215).

The CPU 41 determines whether the wrapping of all labels R of the continuous printing onto the cable 19 has been completed (S217). For example, the CPU 41 determines whether M has reached the total number of cables 19 scheduled for wrapping. If it is determined that the wrapping of all labels R of the continuous printing onto the cable 19 has not been completed (S217: NO), the CPU 41 returns the processing to S203.

The CPU 41 repeats the processing from S203 to S217. As a result, the CPU 41 wraps each of the plurality of printed labels R around one or more cables 19.

When it is determined that all labels R for continuous printing have been completely wrapped around the cable 19 (S217: YES), the CPU 41 terminates the process.

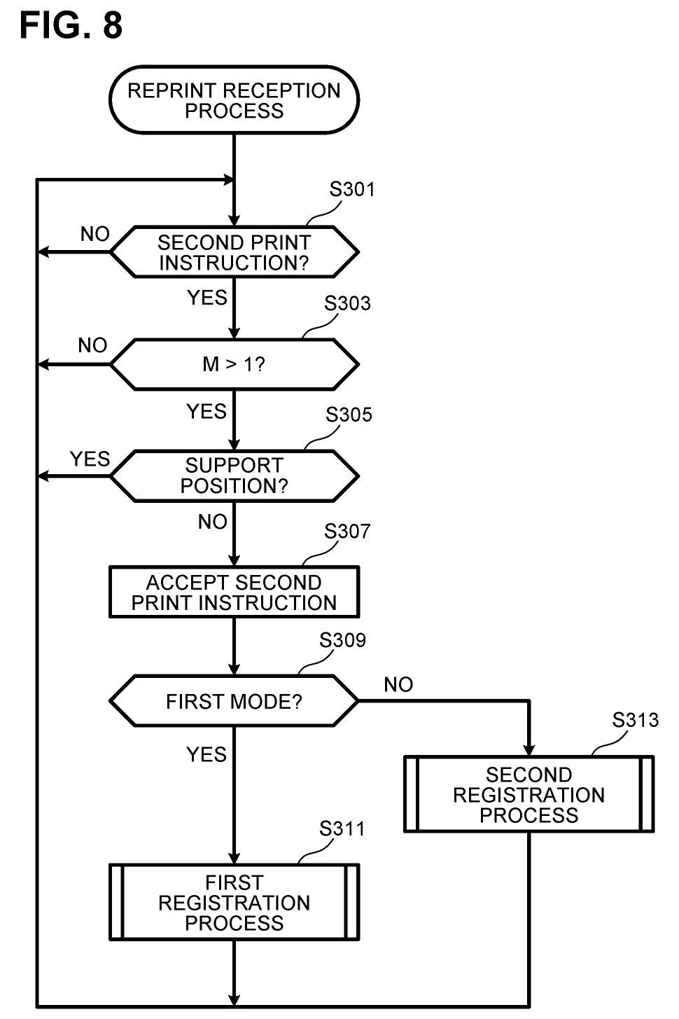

Referring to FIG. 8, reprint reception process will be described. The reprint reception process, similar to the wrapping process, is executed while the continuous printing process is being performed. The CPU 41 reads and executes a program stored in the flash memory 44. The CPU 41 initiates the reprint reception process.

The CPU 41 determines whether a second print instruction has been received (S301). The second print instruction relates to the reprinting of the label R. At least a portion of multiple labels R in continuous printing are subject to reprinting. The user inputs the second print instruction by operating the operation unit 13A.

If it is determined that there is no second print instruction (S301: NO), the CPU 41 returns the processing to S301 and waits.

When it is determined that a second print instruction has been received (S301: YES), the CPU 41 determines whether M is greater than 1 (S303). For example, if the first label R has not yet been wrapped onto the cable 19, M remains at 1. It is thus unclear whether the wrapping of the first label R onto the cable 19 has failed. Therefore, the CPU 41 can determine that the timing of the user's second print instruction is inappropriate.

If it is determined that M is not greater than 1 (S303: NO), that is, when the first label R has not yet been wrapped onto the cable 19, the CPU 41 returns the processing to S301 and waits. In other words, the CPU 41 does not accept the user's second print instruction.

When it is determined that M is greater than 1 (S303: YES), the CPU 41 determines, based on the detection result of the sensor S, whether the cable 19 is set at the support position P3 (S305). If the cable 19 is set at the support position P3, the user has not yet visually confirmed the wrapping result on the cable 19. Therefore, the CPU 41 can determine that the timing of the user's second print instruction is not appropriate.

When it is determined that the cable 19 is set at the support position P3 (S305: YES), the CPU 41 returns the process to S301 and waits. In other words, the CPU 41 does not accept the second print instruction.

If it is determined that the cable 19 is not set at the support position P3 (S305: NO), the CPU 41 accepts a second print instruction (S307). Since the cable 19 is not set at the support position P3, the user visually confirms the wrapping result of the label R and issues the second print instruction by operating the operation unit 13A. Accordingly, the CPU 41 can determine that the timing of the user's second print instruction is appropriate. In other words, when the sensor S detects that the cable 19 is not at the support position P3 after the wrapping process at S211, the CPU 41 accepts the second print instruction during continuous printing.

The CPU 41 determines whether the operating mode of the label affixing apparatus 1 is the first mode (S309).

When it is determined that the operation mode of the label affixing apparatus 1 is the first mode (S309: YES), the CPU 41 executes the first registration process (S311). In the first registration process, a registration of the second print instruction is performed.

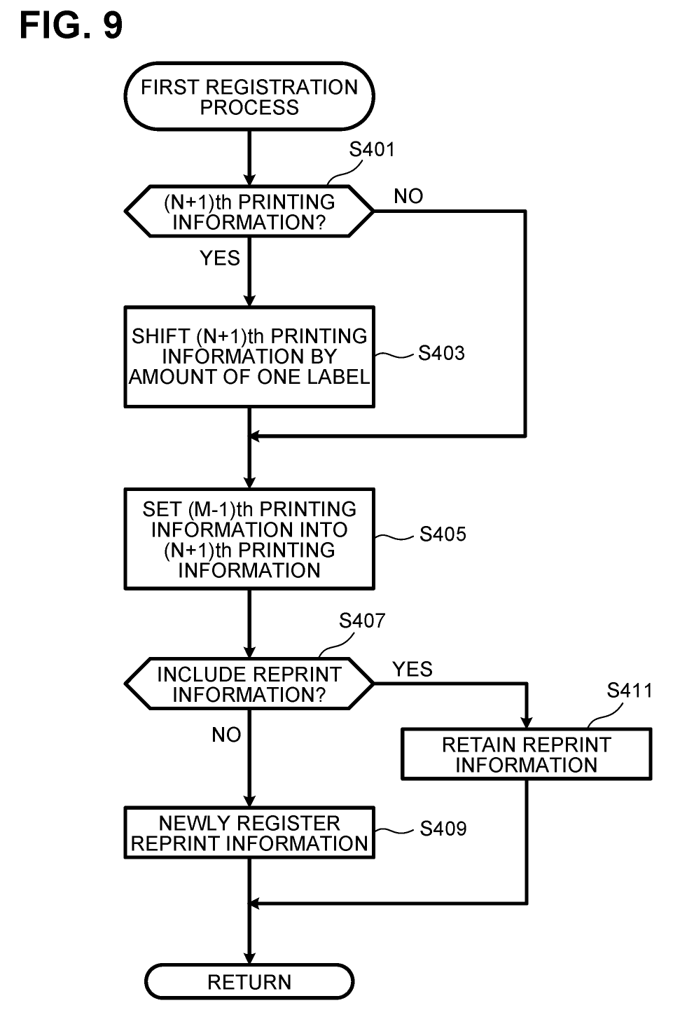

Referring to FIG. 9, the first registration process will be described. When the first registration process is executed, the CPU 41 refers to the management buffer to determine whether printing information for the (N+1)-th label R exists (S401). Here, the Nth label R refers to the label R currently being printed by the printing unit 3. The printing information for the (N+1)-th label R refers to the information of the label R that is waiting to be printed and is the next in line to be printed.

If it is determined that printing information for the (N+1)-th label R exists (S401: YES), the CPU 41 shifts the printing information from the (N+1)-th label onward by the amount of information corresponding to one label (S403). In this case, the printing information for the next label R to be printed, that is, the (N+1)-th label R, becomes empty.

The CPU 41 sets the printing information of the (M-1)-th label R into the printing information of the (N+1)-th label R (S405). In other words, the CPU 41 sets the information of the reprint label R at the position of the (N+1)-th label, which was cleared in step S403, that is, the position targeted for the next printing. It should be noted that the (M-1)-th label's printing information is targeted because M is incremented at step S215, making the printing information of the (M-1)-th label R the subject of reprinting.

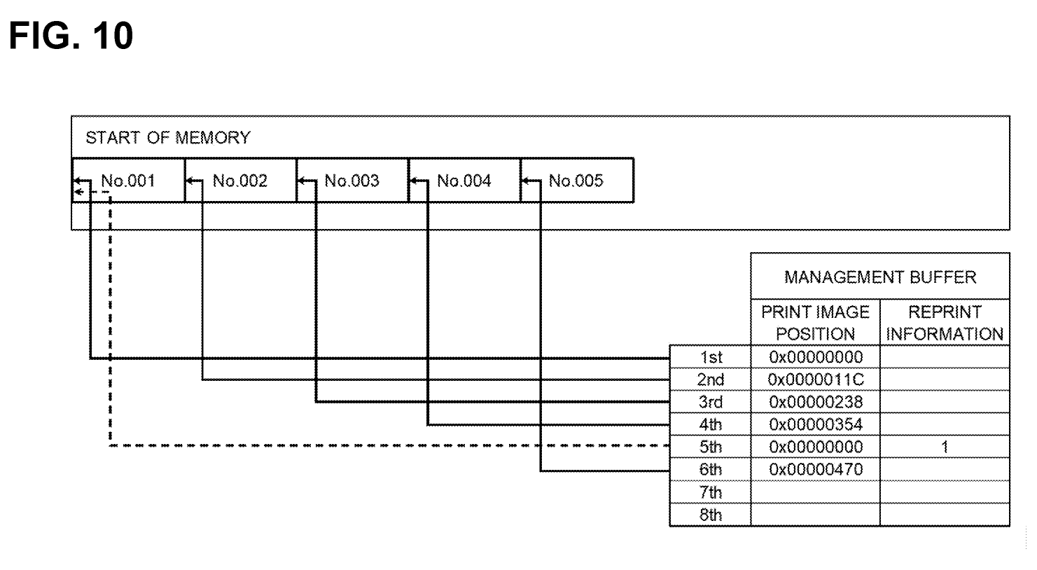

The management buffer shown in FIG. 10 illustrates a failure in wrapping the first label R. At the timing when the user issues the second print instruction, the fourth label R is printed. Accordingly, the print image position of the fifth label R shifts to the sixth label position, and the print image position of the to-be-reprinted first label R is set to the fifth label position.

The CPU 41 determines whether the print information in the management buffer corresponding to the label R for which the second print instruction has been received includes reprint information (S407). In the case where the wrapping of the first label R has failed, the CPU 41 determines whether the print information for the first label R in the management buffer corresponding to the first label R for which the second print instruction has been received includes reprint information. If the reprint information is included, it indicates that the wrapping of the label R subject to the reprint instruction also failed in the previous attempt.

If it is determined that the printing information in the management buffer corresponding to label R, which has received the second print instruction, does not include reprint information (S407: NO), the CPU 41 newly registers reprint information in the printing information at the position of the (N+1)-th label, which became vacant in process S403, that is, the position corresponding to the next print target (S409). The CPU 41 then returns the processing to the reprint reception process.

When returning to the reprint reception process, the CPU 41 returns the processing to S301.

In the management buffer shown in FIG. 10, the reprint information "1" is written at the position corresponding to the fifth print image. The "1" indicates that it is the print information of the first label R of the first print instruction.

When it is determined that the print information in the management buffer corresponding to label R, which has received the second print instruction, includes reprint information (S407: YES), the reprint information is retained (S411). Specifically, the CPU 41 re-registers the reprint information of the print information at the position of the (N+1)-th label, which became vacant in the process of S403, that is, the position corresponding to the next print target (S411).

Although not shown in FIG. 10, for example, if reprinting of the fifth label R in the management buffer, which holds reprint information "1", fails to wrap properly, the reprint information registered upon a second printing instruction will remain "1".

The CPU 41 returns the processing to the reprint reception process.

When returning to the reprint reception process, the CPU 41 returns the processing to step S301.

Here, in the continuous printing process shown in FIG. 4, the labels R are printed in the order of the updated management buffer (S113). Specifically, when a second print instruction is received, the CPU 41 prints the print image of the reprint label R before the print image to be printed next according to the first print instruction. The CPU 41 prints the print images on each of one or more remaining labels R in the continuous printing.

Further, in step S207 of the wrapping process, for example, the system identifies whether the label R corresponds to the Nth label in the original continuous printing and lights the LED that number of times. That is, in the notification of the reprinted label R, the LED blinks according to the amount of reprint information. This allows the user to recognize which number label R it was in the initial first print instruction.

On the other hand, when it is determined that the operation mode of the label affixing apparatus 1 is not the first mode (S309: NO), that is, the second mode, the CPU 41 executes a second registration process (S313).

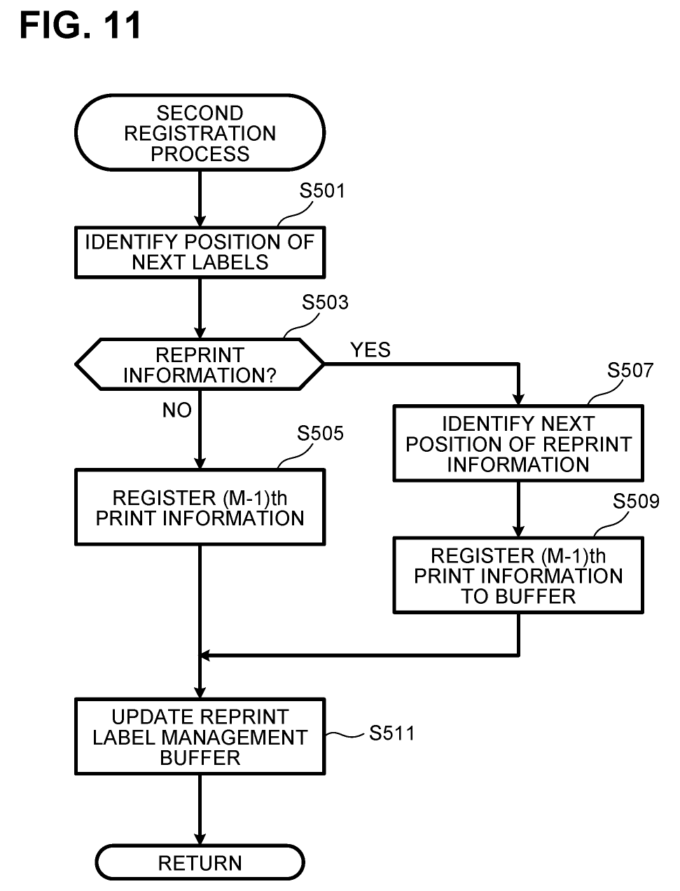

Referring to FIG. 11, the second registration process will be described. The second registration process is a procedure for registering the second print instruction. Unlike the first registration process, the second registration process performs reprinting after printing a predetermined number of labels.

When the second registration process is executed, CPU 41 identifies the positions of the next predetermined number of labels in the print information (S501). The predetermined number of labels is the value set by the user in the process of S105. For example, it is assumed that the predetermined number of labels is set to five.

The CPU 41 refers to the printing information of the label R at the position following the position identified in S501 to determine whether reprint information exists (S503). If it is determined that no reprint information exists (S503: NO), the CPU 41 registers the printing information of (M-1)-th label R at the position following the position of a predetermined number of labels (S505). The CPU 41 then proceeds the processing to S511.

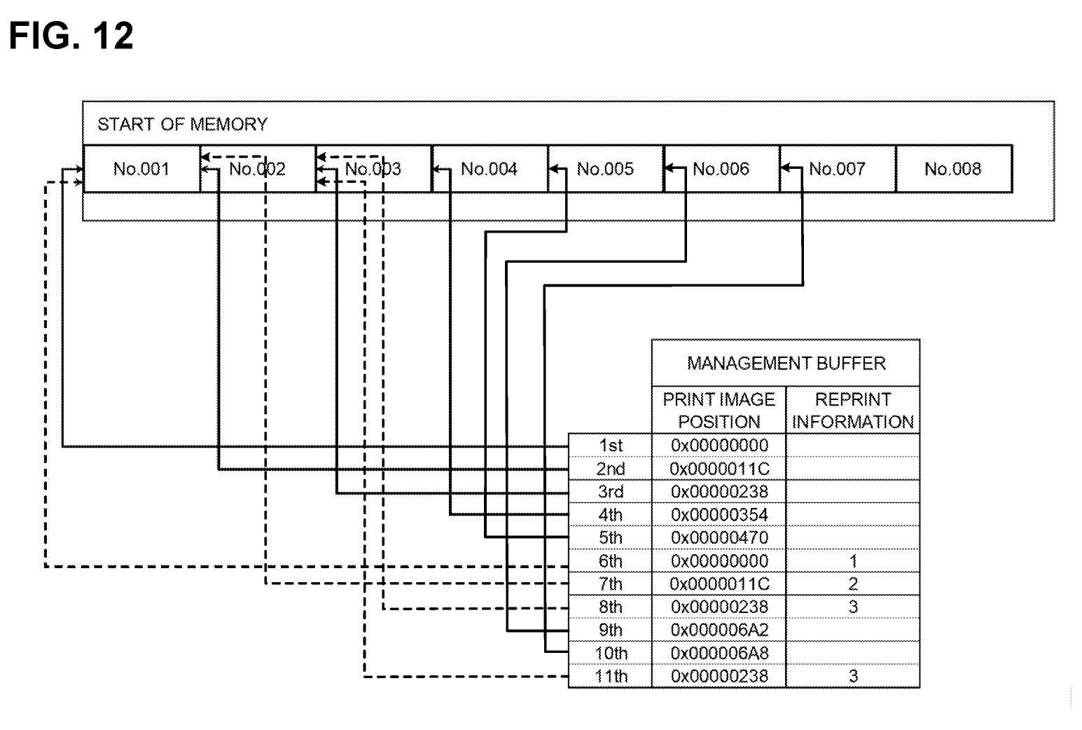

In the management buffer shown in FIG. 12, the predetermined number is set to five. Accordingly, the label R related to reprinting is printed every five sheets. The management buffer illustrates a case where the winding of the first to third labels R fails. Therefore, the print image position of the first label R shifts to the sixth position. At this time, the original sixth label R is shifted back one position each.

If it is determined that reprint information already exists (S503: YES), the CPU 41 identifies the next position of the reprint information (S507). The CPU 41 registers the printing information of the (M-1)-th sheet in the buffer (S509). The CPU 41 then proceeds the processing to S511.

In the management buffer shown in FIG. 12, consecutive failures occur in wrapping the second and third labels R. For example, when the second printing instruction for the second label is accepted, reprint information has already been registered at the position corresponding to the sixth label. Therefore, printing information for the second label R is registered at the position corresponding to the seventh label.

The printing information of the third label R is similarly registered at the position of the eighth label. However, since the reprinting at the eighth position failed, it is re-registered at the position of the eleventh label. In this case, the reprinting information is maintained as "3."

The CPU 41 updates the reprint label management buffer (S511).

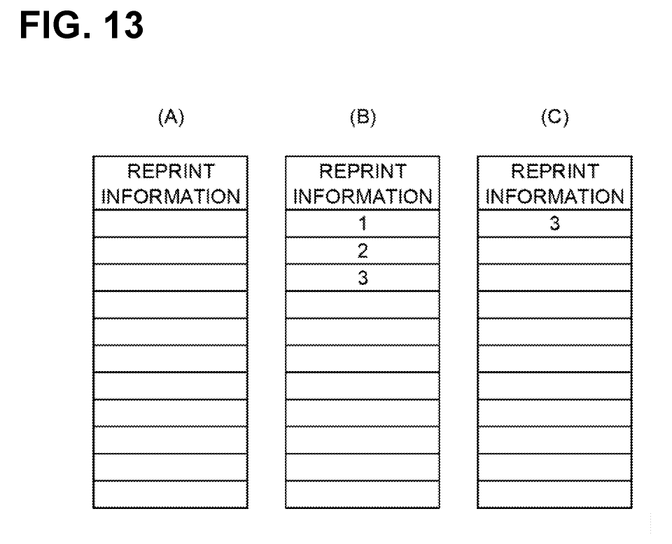

Separate from the management buffer shown in FIG. 12, a reprint label management buffer is updated. In FIG. 13A, the reprint label management buffer is in its initial state, and no reprint information is registered.

FIG. 13B illustrates the management buffer after instructing the reprinting of the third label shown in FIG. 12. In other words, printing has consecutively failed for labels R from the first to the third.

FIG. 13C shows the management buffer after printing the seventh label R of FIG. 12. In this case, the reprint information "1" and "2" are cleared.

The CPU 41 returns the processing to the reprint reception process.

The CPU 41 returns processing to S301.

Here, in the continuous printing process shown in FIG. 4, the CPU 41 performs printing of a predetermined number of labels R according to the first print instruction. Subsequently, the CPU 41 prints the respective print images corresponding to each label R related to the second print instruction.

In S207 of the wrapping process, the CPU 41 causes the LED to blink, similar to the first registration process.

As described above, the CPU 41 prints, on each of the plurality of labels R, a printing image corresponding to each label R in accordance with the received first printing instruction via the printing unit 3. The CPU 41 causes the wrapping unit 7 to wrap each of the multiple printed labels R onto one or more cables 19. The CPU 41 receives a second printing instruction concerning the reprinting of at least a portion of the multiple labels R. Upon receiving the second printing instruction, the CPU 41 causes the printing unit 3 to print, on each of the labels R corresponding to at least a part thereof, printing images corresponding to each of those labels R.

Thus, the label affixing apparatus 1 is configured to reprint the label R.

The CPU 41 receives a second print instruction during continuous printing. After reprinting in response to the second print instruction, the CPU 41 prints on each of one or more remaining labels R in the continuous printing sequence. The label affixing apparatus 1 performs reprinting labels R during continuous printing.

The conveying unit 2 transports the label R printed by the printing unit 3. An insertion port 73, into which a cable 19 partially attached with the label R is inserted, is arranged in the wrapping unit 7. The wrapping unit 7 includes a rotating member 70. The rotating member 70 rotates while supporting the cable 19 inserted through the insertion port 73. The wrapping unit 7 wraps the label R onto the cable 19 by the rotation of the rotating member 70. The CPU 41 controls the conveying unit 2 to transport the label R printed by the printing unit 3 to a stop position P1 upstream of the insertion direction in which the cable 19 is inserted into the insertion port 73. The CPU 41 issues a notification when the label R printed in the first process is conveyed to the stop position P1. The user can recognize that a reprinted label R is conveyed to the stop position P1.

The label affixing apparatus 1 is further equipped with a notification unit 13B. The CPU 41 accepts a second print instruction for reprinting the Nth label R in continuous printing. The CPU 41 prints the image corresponding to the Nth label R for which the reprint instruction was accepted. The CPU 41 causes the notification unit 13B to blink N times. This allows the user to recognize that the reprinted label R corresponds to the Nth label R for which the second print instruction was received.

The label affixing apparatus 1 further includes an operation unit 13A for inputting a second print instruction. The CPU 41 accepts the second print instruction when the operation unit 13A is operated. Thus, the user can input a reprint instruction for the label R through a simple operation.

The sensor S detects whether the cable 19 inserted through the insertion port 73 is positioned at the support position P3. The CPU 41, upon detection by the sensor S that the cable 19, onto which the Nth label R in a series of continuous printings is to be wrapped, is at the support position P3, winds the Nth label R onto the cable 19. After the winding process, if the sensor S detects that the cable 19 is no longer at the support position P3, the CPU 41 accepts a second print instruction for reprinting the Nth label R. The user may desire to recognize a failure in wrapping and issue a reprint instruction after removing the cable 19 following the winding process of the Nth label R. Therefore, the label affixing apparatus 1 appropriately controls the timing for accepting the second print instruction.

For example, the user holds the cable 19 with both hands. The user inserts the cable 19, held with both hands, into the wrapping unit 7. After completing the wrapping at the wrapping unit 7, the user removes the cable 19 with both hands. Then, the user checks whether the label R has been successfully wrapped onto the cable 19. If the wrapping is successful, the user holds the next cable 19 with both hands and inserts it into the wrapping unit 7. On the other hand, if the wrapping is unsuccessful, the user releases the cable 19 and presses the operation unit 13A to instruct reprinting. Considering the above sequence, it is easier for the user to understand when the reprint instruction is received while the cable 19 is not at the wrapping position. Accepting the reprint instruction when the cable 19 is at the wrapping position makes it unclear to the user whether the reprint instruction should apply to the cable 19 currently at the support position P3 or to the cable 19 that was previously at the support position P3. Moreover, since the user's hands are typically occupied at this timing, there is a possibility of erroneous operation such as the elbow hitting the unit.

When the CPU 41 receives the second print instruction, it prints the print image corresponding to each of at least a part of labels R before the print image to be printed next according to the first print instruction. Upon receiving the second print instruction, the label affixing apparatus 1 can perform reprinting the label R at an early timing.

When the CPU 41 receives the second print instruction, it performs printing according to the first print instruction, and after printing a predetermined number of labels R, it prints a print image corresponding to at least some of the labels R. When the label affixing apparatus 1 receives the second print instruction, reprinting is executed after printing the predetermined number of labels R. Therefore, the user can recognize that reprinting is performed after printing the predetermined number of labels R.

The CPU 41 accepts a predetermined number of settings. The user can set the timing for executing reprinting.

In the above description, the notification unit 13B is an example of the "light emitting unit" of the present invention. The cable 19 is an example of the "rod-shaped member" of the present invention. The operation unit 13A is an example of the "input unit" of the present invention. The sensor S is an example of the "detection unit" of the present invention.

The process in step S107 is an example of the "first reception process" of the present invention. The process in step S113 is an example of the "printing process" of the present invention. The process in step S211 is an example of the "wrapping process" of the present invention. The process in step S307 is an example of the "second reception process" of the present invention. The processes in steps S307 and S113 are examples of the "first process" of the present invention.

The process of S405 and S113 are examples of the "second process" of the present invention. The process of S111 is an example of the "transport process" of the present invention. The process of S207 is an example of the "notification process" of the present invention. The process of S105 is an example of the "setting" of the present invention.

The above embodiment can be variously modified as described below. The above disclosure and the various modifications described hereinafter can be combined as long as no contradictions arise. The configuration of the label affixing apparatus 1 in the above embodiment may be appropriately changed. The arrangement positions of the components may also be appropriately altered.

The label affixing apparatus 1 may not only receive continuous print data from an external terminal 48 but also be configured to generate continuous print data. The reprint instruction may be issued not only via the operation unit 13A but also from the external terminal 48. The reprint instruction may be issued not only when the wrapping of the label R fails but also when printing on the label R fails. The reprint instruction may be issued not only when any of the printing, conveying, or wrapping processes fail but also whenever the user desires to reprint the label R.

In the above embodiment, the user selects either the first mode or the second mode; however, the invention is not limited to this configuration. For example, only the first mode may be executed, or only the second mode may be executed. When executing only the first mode, steps S101, S103, S105, and the second registration process may be omitted. When executing only the second mode, steps S101, S103, and the first registration process may be omitted.

In the above embodiment, the predetermined number of sheets was five; however, the present invention is not limited thereto. The predetermined number of sheets may be appropriately changed as needed. When the predetermined number of sheets is accepted, switching between the first mode and the second mode may be performed.

In the above embodiment, the object around which the label R is wrapped is the cable 19; however, the invention is not limited thereto. For example, the object may be stationery such as a pen, or tools such as a screwdriver.

In the above embodiment, the notification unit 13B is an LED; however, this is not limiting. The notification unit 13B may be a light-emitting element other than an LED. Alternatively, the notification unit 13B may be a buzzer. Furthermore, the notification unit 13B may be a display screen such as an LCD.

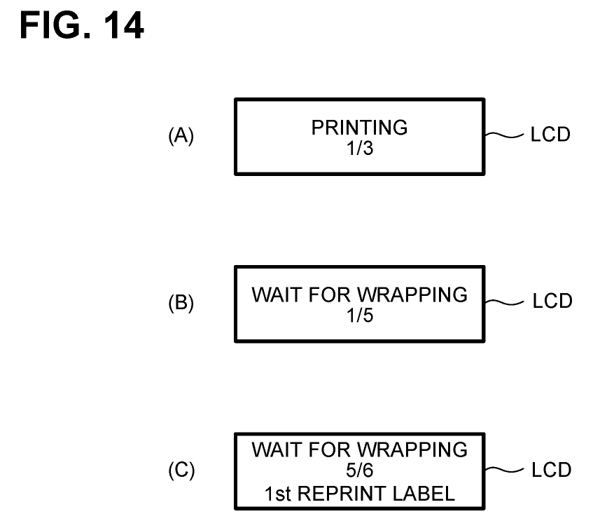

For example, the label affixing apparatus 1 may be equipped with a display LCD as shown in FIG. 14. The display LCD shown in FIG. 14A indicates that three prints are to be continuously made and that the first print is currently in progress. The display LCD shown in FIG. 14B indicates the total number of cables 19 scheduled for wrapping and the order in which they are waiting. The display LCD shown in FIG. 14C indicates that the cable 19 waiting is in the fifth position. Additionally, it indicates whether the label R currently being printed is a reprint label.

In the above embodiment, a microcomputer, an ASIC (Application Specific Integrated Circuit), an FPGA (Field Programmable Gate Array), or the like may be used as the processor instead of the CPU 41. Each process executed by the program may be distributed and processed by multiple processors.

The program may be downloaded from a server connected to the Internet, which is not shown in the drawings (i.e., transmitted as a transmission signal), and stored in a non-volatile memory. In this case, the program may be stored in a non-transitory storage medium such as an HDD provided in the server.

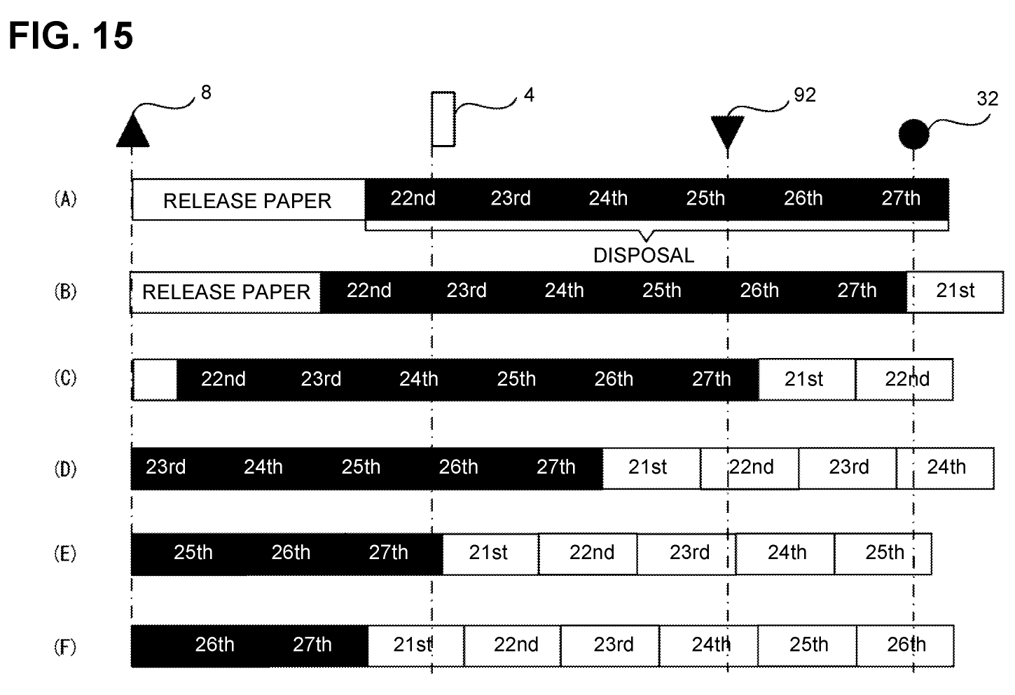

As shown in FIGS. 15 to 23, the user may execute the third mode without executing the first mode or the second mode. In the third mode, upon receiving the second print instruction, printing is performed in the original order on the labels R related to reprinting, and the labels are wrapped onto the cable 19. Labels R that have already been printed by the printing unit 3 at the time of receiving the second print instruction are taken-up and discarded as is by the take-up unit 8.

For example, in the example shown in FIG. 15, it is assumed that the second print instruction is received with the 21st label R.

FIG. 15A indicates that six labels of the 22nd label R to the 27th label R have already been printed. These six labels R are subject to disposal after taken-up.

The boundary between the 22nd label R and the 23rd label R has already been cut by the half-cutting blade 92. The boundary between the 23rd label R and the 24th label R has already been cut by the half-cutting blade 92. The boundary between the 24th label R and the 25th label R has already been cut by the half-cutting blade 92. The boundary between the 25th label R and the 26th label R has not been cut. The boundary between the 26th label R and the 27th label R has not been cut.

FIG. 15B indicates that the 21st label R is reprinted immediately after the 27th label R, which is to be discarded. The 22nd label R to be discarded passes through the peeling part 4 and is conveyed toward the take-up unit 8. When transitioning from the state in FIG. 15A to the state in FIG. 15B, the boundary between the 25th and 26th labels R is not cut by the half-cutting blade 92.

FIG. 15C indicates that the 21st label R, which is subject to reprinting, is conveyed toward the half-cutting blade 92. The twenty-first label R is cut by the half-cutting blade 92. Simultaneously, the 22nd label R, also subject to reprinting, is printed by the thermal head 32. The 23rd label R, which is to be discarded, passes through the peeling part 4 and is conveyed to the take-up unit 8. When transitioning from the state in FIG. 15B to the state in FIG. 15C, the boundary between the 26th label R and the 27th label R is not cut by the half-cutting blade 92.

FIG. 15D indicates that the 21st label R after cutting is conveyed toward the peeling part 4. Simultaneously, the thermal head 32 prints the 24th label R for reprinting. The 24th and 25th labels R, which are to be discarded, pass through the peeling part 4 and are conveyed toward the take-up unit 8. When transitioning from the state in FIG. 15C to the state in FIG. 15D, the boundary between the 27th label R and the 21st label R, and the boundary between the 21st label R and the 22nd label R are cut by the half-cutting blade 92.

FIG. 15E indicates that the 21st label R is conveyed toward the peeling part 4. The thermal head 32 prints the 25th label R for reprinting. The 26th and 27th labels R, which are to be discarded, are conveyed past the peeling part 4 toward the take-up unit 8. When transitioning from the state in FIG. 15D to the state in FIG. 15E, the boundary between the 22nd label R and the 23rd label R is cut by the half-cutting blade 92.

FIG. 15F indicates that the 21st label R is peeled from the release paper Rp at the peeling part 4. The thermal head 32 prints the 26th label R for reprinting. The 27th label R, which is to be discarded, passes through the peeling part 4 and is conveyed toward the take-up unit 8. When transitioning from the state in FIG. 15E to the state in FIG. 15F, the boundary between the 23rd label R and the 24th label R is cut by the half-cutting blade 92.

Subsequently, the 27th label R to the 30th label R are sequentially printed, sequentially cut by the half-cutting blade 92, and sequentially peeled at the peeling part 4.

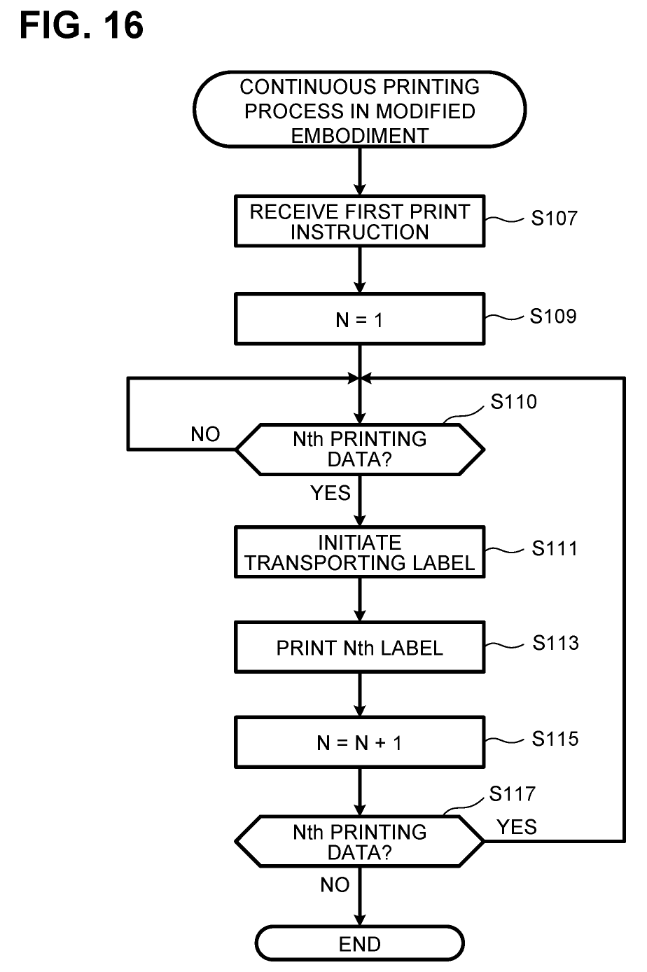

Referring to FIGS. 16 to 23, each process executed in the third mode will be described. In the third mode, the label affixing apparatus 1 performs continuous printing process, wrapping process, reprint reception process, take-up process, buffer process, and notification processing. In the following descriptions of each process, the same step numbers as those in the above embodiment are assigned to identical steps, and detailed explanations thereof are omitted. The wrapping process in the modified example is the same as that in the above embodiment; therefore, its description is omitted.

Referring to FIG. 16, the continuous printing process of a modified embodiment will be described. The start trigger for the continuous printing process is the same as that in the above embodiment. In the continuous printing process of the modified embodiment, the CPU 41 does not execute steps S101, S103, and S105 of the continuous printing process of the above embodiment, but executes step S110. For convenience of explanation, the number of continuous print sheets is set to 30, that is, the maximum number of N is 30.

When the continuous printing process is initiated, the CPU 41 accepts the first print instruction in the same manner as in the above embodiment (S107). The CPU 41 sets N to 1 (S109).

The CPU 41 determines whether printing data for the Nth label R exists in the management buffer (S110). If the CPU 41 determines that the printing data for the Nth label R does not exist in the management buffer (S110: NO), the CPU 41 returns the processing to step S110 and waits.

If it is determined that the printing data for the Nth label R is present in the management buffer (S110: YES), the CPU 41 initiates the conveyance of the label R (S111).

The CPU 41 prints the Nth label R based on the Nth printing data in the management buffer (S113).

When printing is completed, the CPU 41 increments N by 1 (S115).

The CPU 41 determines whether there is print data for the Nth label R in the management buffer (S117) after incrementing N.

When it is determined that there is print data for the Nth label R (S117: YES), the CPU 41 returns the processing to S110. The CPU 41 repeats the processing from S110 to S117 to perform continuous printing.

On the other hand, when it is determined that there is no print data for the Nth label R (S117: NO), the CPU 41 terminates the continuous printing process.

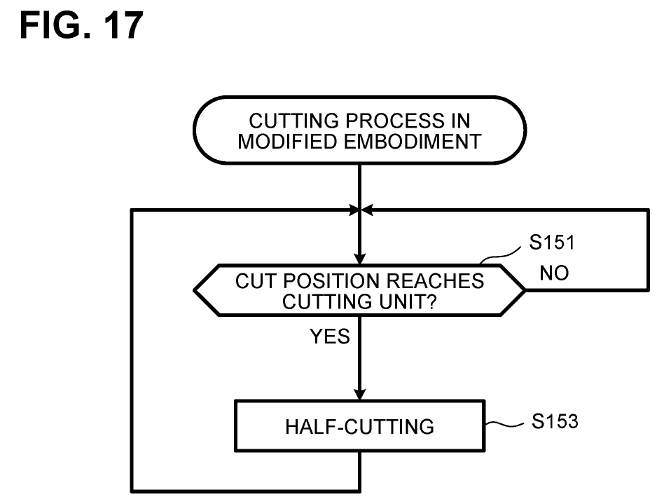

Referring to FIG. 17, the cutting process of the modified example will be described. The cutting process is executed while continuous printing is being performed. The CPU 41 reads and executes a program stored in the flash memory 44. The CPU 41 initiates the cutting process.

When the cutting process is initiated, the CPU 41 determines whether the cut position of the label R has reached the cutting unit 9 (S151). The print data for each of the multiple labels R includes information regarding the cut position of the label R. The cut position information of the label R corresponds to the cutting position at the front end of the label R. Alternatively, the cut position information may include the cutting position at the rear end of the label R. The cut position of the label R can be identified based on position information from an encoder of the drive motor or detection results from an optical sensor.

If it is determined that the cut position of label R has not reached the cutting section 9 (S151: NO), the CPU 41 returns the processing to S151 and waits.

When it is determined that the cutting position of the label R has reached the cutting unit 9 (S151: YES), the CPU 41 controls the cutting unit 9 to cut the film tape Rf without cutting the release paper P, i.e., to half-cut the label R (S153).

The CPU 41 returns the processing to S151.

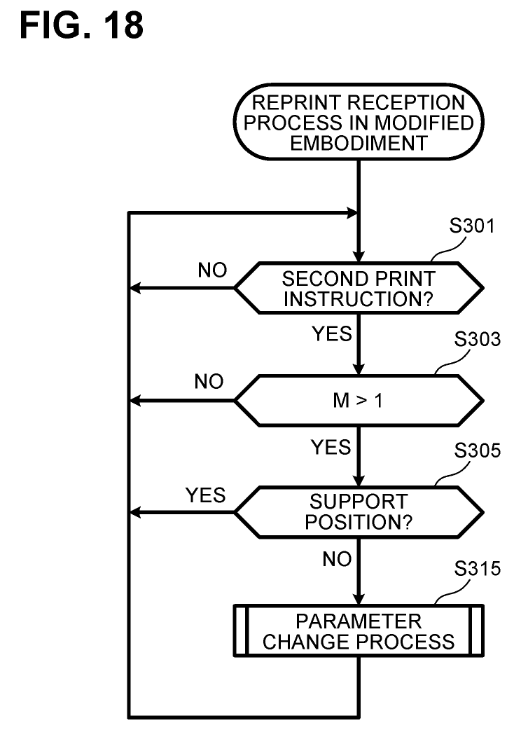

Referring to FIG. 18, the reprint reception process of the modified example will be described. The reprint reception process of the modified example differs from the reprint reception process of the above embodiment in that step S315 is executed instead of steps S307 to S313. The other processes, namely steps S301, S303, and S305, are the same as those in the reprint reception process of the above embodiment. Therefore, detailed description thereof is omitted.

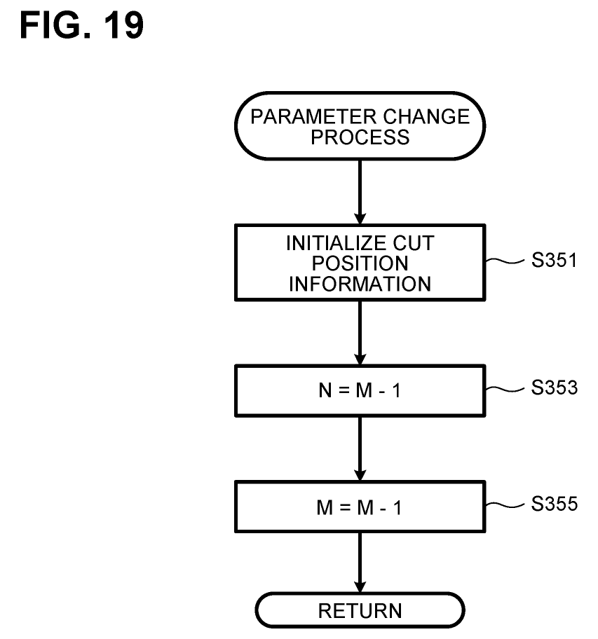

Upon initiation of the reprint reception process, the CPU 41 executes steps S301 through S305. If it is determined that the cable 19 is not set at the support position P3 (S305: NO), the CPU 41 performs parameter change process shown in FIG. 19 (S315).

When the parameter change process shown in FIG. 19 is executed, the CPU 41 initializes the cut position information included in the print data (S351). In the example in FIG. 15A, the cut position information for the 26th and 27th labels R is initialized. Because of this initialization, the CPU 41 does not perform cutting of the 26th and 27th sheets during the cutting process in FIG. 17. In other words, after receiving the second print instruction, the CPU 41 refrains from executing cutting by the cutting unit 9 until the 21st label R reaches the cutting unit 9.

The CPU 41 sets N to M-1 (S353). For example, when a cable 19 that failed to be wrapped is removed from the support position P3, the CPU 41 increments M in the wrapping process at S215. Therefore, the CPU 41 identifies the label R subject to reprinting by M-1. Consequently, in the continuous printing process, the CPU 41 can accurately specify the label R for reprinting.

The CPU 41 sets M to M-1 (S355). For example, when a cable 19 that failed to be wapped is removed from the support position P3, the CPU 41 increments M during the winding process at S215. Therefore, the CPU 41 determines the number of labels R successfully wrapped before receiving the second print instruction as M-1. As a result, the CPU 41 can accurately identify the labels R that have been successfully wrapped.

The CPU 41 returns the processing to the reprint reception process.

When returning the processing to the reprint reception process, the CPU 41 returns the processing to step S301.

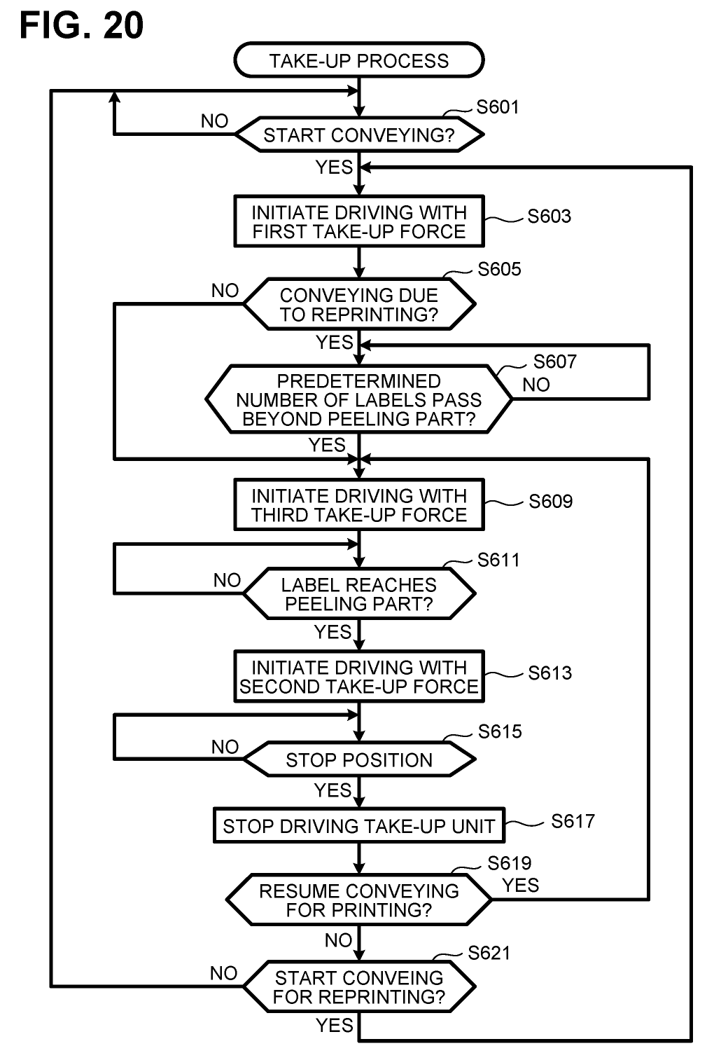

Referring to FIG. 20, the modified embodiment of the take-up process will be described. The take-up process is executed during continuous printing operations. The CPU 41 reads and executes a program stored in the flash memory 44. The CPU 41 initiates the take-up process.

When the take-up process is initiated, the CPU 41 determines whether the conveying unit 2 has started conveying the label R during continuous printing process (S601). If it is determined that the conveying unit 2 has not started conveying the label R (S601: NO), the CPU 41 returns the processing to S601 and waits.

When it is determined that the conveyance of the label R by the conveying unit 2 has started (S601: YES), the CPU 41 initiates driving of the take-up unit 8 with a first take-up force (S603). Here, the CPU 41 adjusts take-up force of the take-up unit 8 by changing torque of the drive motor of the take-up unit 8. Specifically, the CPU 41 sets the torque of the drive motor low to set the take-up force of the take-up unit 8 low. Conversely, the CPU 41 sets the torque of the drive motor high to set the take-up force of the take-up 8 high.

The first take-up force is smaller than reference take-up force. The reference take-up force is equal or equivalent to the adhesive force of the label R adhered to the release paper Rp. Since the first take-up force is smaller than the reference take-up force, the label R is not peeled from the release paper Rp during taken-up at the take-up unit 8.

For example, immediately after the start of the continuous printing process, unnecessary labels R and release paper Rp located downstream in the transport direction are taken-up to the take-up unit 8 by the first take-up force.

The CPU 41 determines whether the conveyance of the label R during printing is due to reprinting based on the second print instruction (S605). If it is determined that the conveyance is not due to reprinting based on the second print instruction (S605: NO), the CPU 41 starts driving the take-up unit section 8 with the third take-up force (S609).

The third take-up force is greater than the first take-up force and less than the reference take-up force. Therefore, even when switching from the first take-up force to the third take-up force, the label R does not peel off from the release paper Rp at the peeling part 4. Here, when driven with the first take-up force, a difference between the conveyance speed of the label R at the take-up unit 8 and the conveyance speed of the label R at the printing unit 3 may cause the label R and the release paper Rp to bend. By switching from the first take-up force to the third take-up force, the bent state of the label R and the release paper Rp can be restored to the desired posture.

The CPU 41 determines whether the label R related to printing has reached the peeling part 4 (S611). The label R reaching the peeling part 4 means that the label R has arrived at a position where it can be peeled off from the release paper Rp.

The preferred position is immediately before the downstream end of the 21st label R in the transport direction Y2, shown in FIG. 15E, reaches the peeling part 4. In other words, the label R reaching the peeling part 4 means that the downstream end of the label R to be peeled in the transport direction Y2 has arrived upstream of the peeling part 4 by a predetermined distance. However, the label R reaching the peeling part 4 may also mean that the downstream end has reached the peeling part 4. Furthermore, the label R reaching the peeling part 4 may refer to either the downstream end of the label R to be peeled having arrived downstream of the peeling part 4 by a predetermined distance.

If it is determined that the label R related to printing has not reached the peeling part 4 (S611: NO), the CPU 41 returns the processing to S611 and waits. During this time, the CPU 41 drives the take-up unit 8 with a third take-up force to convey the label R and the release paper Rp to the peeling part 4.

When it is determined that the label R related to printing has reached the peeling part 4 (S611: YES), the CPU 41 starts driving the take-up unit 8 at the second take-up force (S613). The second take-up force is greater than the reference take-up force. Accordingly, the label R is peeled off from the release paper Rp at the peeling part 4. The take-up unit 8 takes-up the release paper Rp from which the label R has been peeled off at the peeling part 4.

The CPU 41 determines whether the label R is at the stop position P1 (S615). If it is determined that the label R is not at the stop position P1 (S615: NO), the CPU 41 returns the processing to S615 and waits. During this time, the CPU 41 transports the label R, which has been peeled off at the peeling part 4, to the stop position P1.

When it is determined that the label R is at the stop position P1 (S615: YES), the CPU 41 stops the drive of the take-up unit 8 (S617). Specifically, the CPU 41 stops the drive motor of the take-up unit 8. While the drive of the take-up unit 8 is stopped, the user performs an operation such as wrapping the label R onto the cable 19.

The CPU 41 determines whether the conveyance of the label R by the conveying unit 2 has resumed during continuous printing processing (S619). If it is determined that the conveyance of the label R by the conveying unit 2 has resumed (S619: YES), the CPU 41 returns the processing to S609.

The CPU 41 repeatedly executes the process from S609 to S619, thereby sequentially performing taking-up based on the first print instruction. If a second print instruction is not received, the CPU 41 sequentially executes the transport by taking-up until the 30th label R.

If it is determined that the label R has not resumed being conveyed by the conveying unit 2 (S619: NO), the CPU 41 determines whether the conveying of the reprinted label R, instructed by the second print command, has started (S621).

If it is determined that the conveyance for reprinting has not started (S621: NO), the CPU 41 returns the processing to S601. For example, in the case shown in FIG. 15, when the conveyance of the 30th label R is completed, the processing returns to S601.

On the other hand, when it is determined that the conveyance of the label R by reprinting in response to the second print instruction has started (S621: YES), the CPU 41 returns the processing to S603. Specifically, upon receiving the second print instruction, the CPU 41 drives the take-up unit 8 with the first take-up force to take-up the release paper Rp with the label R still adhered and not peeled off at the peeling part 4 (S603). Since the take-up force is the first take-up force, the label R intended for disposal is not peeled off from the release paper Rp.

In the state shown in FIG. 15A, the downstream end of the 22nd label R to be discarded in the transport direction Y2 is located downstream of the peeling part 4. Therefore, the downstream end of the 22nd label R is detached from the release paper Rp. On the other hand, the upstream end of the 22nd label R in the transport direction Y2 is located upstream of the peeling part 4. Accordingly, the upstream end of the 22nd label R remains adhered to the release paper Rp. In this case, since the take-up force is the first take-up force, the 22nd label R is taken-up onto the take-up unit 8 while maintaining the adhesion between the upstream end of the 22nd label R and the release paper Rp.

Here, if it is determined that the label is a reprint (S605: YES), the CPU 41 determines whether a predetermined number of labels R related to the reprint have passed beyond the peeling part 4 (S607).

The predetermined number of labels is determined by the distance between the printing unit 3 and the peeling part 4, and the length of each label R in the conveyance direction Y1. In the example shown in FIG. 15, the predetermined number of labels is four. The predetermined number of labels corresponds to the number of labels R retained between the printing unit 3 and the peeling part 4.

In the example shown in FIG. 15, the 22nd to 25th labels R are cut by the half-cutting blade 92. Since the first take-up force is set, the possibility of the labels R being peeled off from the release paper Rp is reduced. The 22nd to 25th labels R are not peeled off from the release paper Rp even when passing through the peeling part 4.

When it is determined that the predetermined number of labels R has passed beyond the peeling part 4 (S607: YES), the CPU 41 initiates driving of the take-up unit 8 with the third take-up force (S609). Accordingly, the CPU 41 corrects any deflection occurring in the label R and the release paper Rp, thereby restoring the label R and the release paper Rp to their proper posture. In the example shown in FIG. 15, the 26th and 27th labels R are not cut, and the third take-up force is lower than the reference take-up force. Therefore, even when driven with the third take-up force, the likelihood of the label R being erroneously peeled from the release paper Rp is low.

When it is determined that the label R related to reprinting has reached the peeling part 4 (S611: YES), the CPU 41 drives the take-up unit 8 with the second take-up force to peel the label R from the release paper Rp at the peeling part 4 (S613). In the example of FIG. 15, the twenty-first label R is peeled from the release paper Rp.

The CPU 41 transports the label R to the stop position P1 (S615: YES) and, for example, waits for the 21st label R shown in FIG. 15 to be wrapped around the cable 19 (S617). When the cable 19 is removed from the support position P3, the CPU 41 resumes transporting the next label R (S619: YES) and transports the next label R to the peeling part 4. For example, the 22nd label R shown in FIG. 15 is transported toward the peeling part 4.

The CPU 41 executes the remaining continuous printing by repeating steps S609 to S619. In the example shown in FIG. 15, the CPU 41 carries out the transport of labels R from the 22nd to the 30th.

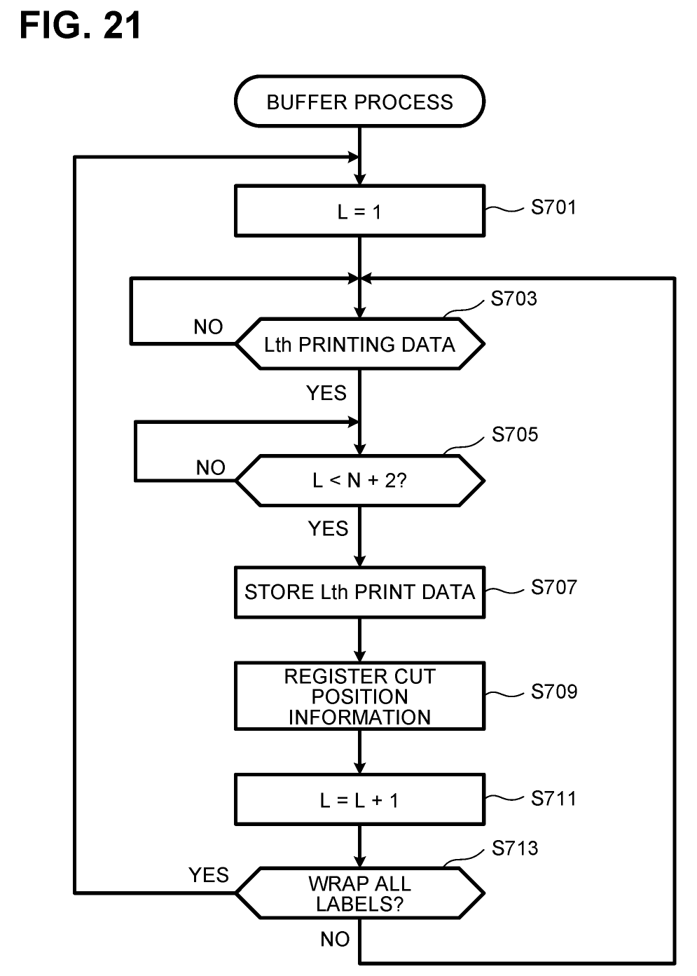

Referring to FIG. 21, the buffer process of the modified example will be described. The buffer process is executed during continuous printing operations. The CPU 41 reads and executes a program stored in the flash memory 44. The CPU 41 initiates the buffer process.

When the buffer process starts, the CPU 41 sets L to 1 (S701). L is an integer. L indicates the number of the converted print data in the first print instruction. For instance, L = 1 corresponds to the number of the print data for the first label R in the first print instruction.

The CPU 41 determines whether the Lth print data exists (S703). If it is determined that no print data exists (S703: NO), the CPU 41 returns the processing to S703 and waits.

If it is determined that the Lth print data exists (S703: YES), the CPU 41 determines whether L is less than N+2 (S705).

If it is determined that L is greater than or equal to N+2 (S705: NO), the CPU 41 returns the process to S705 and waits.

If it is determined that L is less than N+2 (S705: YES), the CPU 41 stores the Lth print data in the L/X-th region of the management buffer (S707).

X indicates the number of print data sets for the label R required for reprinting. In the example of FIG. 15, X is seven. Preferably, X corresponds to the maximum number of labels R that can remain between the thermal head 32 and the half-cutting blade 92. The maximum number is determined by the distance between the thermal head 32 and the half-cutting blade 92, and the length of the label R in the conveyance direction Y1. It should be noted that X is not limited to the maximum number and may be any integer.

For example, when N=1 and L=1, the printing data of the first label R is stored in the 1/7th region.

The CPU 41 registers information regarding the cut position of the Lth label R (S709). The cut position information is associated with the print data of the Lth label R.

The CPU 41 increments L by 1 (S711). For example, the CPU 41 sets L from 1 to 2.

The CPU 41 determines whether the wrapping of all labels R has been completed (S713). For example, The CPU 41 determines that the wrapping is completed if the value M is set to 30.

If it is determined that the wrapping of all labels R has not been completed (S713: NO), the CPU 41 returns the processing to S703.

For example, when L=2 and N=1, since L is less than N+2 (S705: YES), the CPU 41 stores the image data of the second label R in the 2/7th region (S707). As a result, the printing data of the most recent two labels is stored. The cut position registration of the second label R is performed (S709). The CPU 41 then sets L to 3 (S711).

By executing S705, the CPU 41 can store print data for at least two labels during the printing of the first label R. Therefore, even if reprinting of the first label R is requested, the label affixing apparatus 1 can continuously and smoothly perform the printing and conveyance operations for the second label R.

In S705, the minimum number of stored labels can be changed by applying N+3 instead of N+2. For example, when N+3 is applied, the number of labels R that can be continuously printed after receiving the second print instruction can be set to three. For instance, the faster the printing speed of one label R, the greater the minimum number of stored labels should be.

For example, when L=3 and N=1, L is greater than or equal to N+2 (S705: NO). Therefore, the CPU 41 waits at step S115 of the continuous printing process shown in FIG. 16 until N is incremented.

The CPU 41 repeats the processes S703 to S713 seven times to store printing data for reprinting from the 1/7th to the 7/7th regions (S707). For example, when L has been incremented up to 7 and N has been incremented up to 6 (S705: YES), the CPU 41 stores printing data for seven labels for reprinting (S707).

In S707, when L is 8, the remainder of L divided by X, i.e., the remainder of 8 divided by 7, is 1. Therefore, the printing data of label R number 8 is overwritten and saved in the 1/7th region. When L is 9, the remainder of L divided by X is 2. Accordingly, the printing data is overwritten and saved in the 2/7th region (S707). By repeating this process, the CPU 41 updates the printing data for reprinting by overwriting the oldest printing data among the seven stored sets of printing data.

On the other hand, when it is determined that the wrapping of all labels R is completed (S713: YES), the CPU 41 returns the processing to S701.

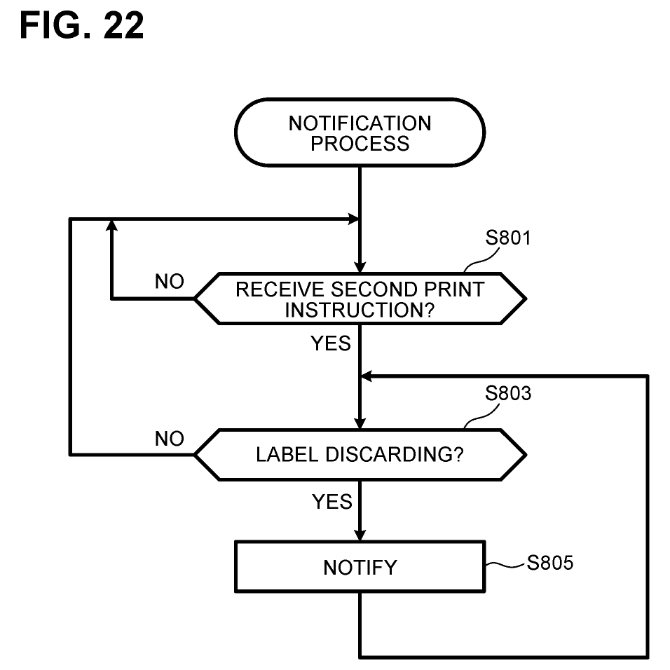

Referring to FIG. 22, the notification processing according to a modified example will be described. The notification processing is executed while continuous printing processing is being performed. The CPU 41 reads and executes a program stored in the flash memory 44. The CPU 41 initiates the notification processing.

When the notification processing is initiated, the CPU 41 determines whether a second print instruction has been received (S801). If it is determined that the second print instruction has not been received (S801), the CPU 41 returns the processing to S801 and waits.

When it is determined that the second print instruction has been received (S801: YES), the CPU 41 determines whether the label R is being discarded (S803). Here, in the take-up process of FIG. 20, after receiving the second print instruction, the CPU 41 causes the take-up unit 8 to take-up the release paper Rp, to which the label R is adhered without being peeled off at the peeling part 4 (S603 to S607). For example, in the example of FIG. 15, the CPU 41 determines that the 22nd to the27th labels R are being taken-up by the take-up unit 8, and determines the label R being discarded.

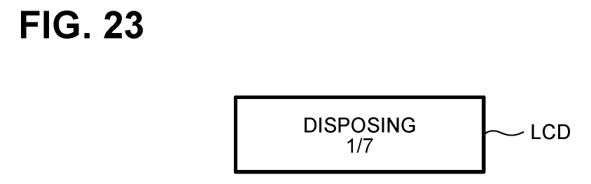

For example, when the label R is determined to be discarded (S803: YES), the CPU 41 notifies that the take-up unit 8 is taking-up the release paper Rp in a state where the label R remains adhered without being peeled off at the peeling part 4 (S805). The CPU 41 displays a screen as shown in FIG. 23. The notification may be provided not only by a message on the screen but also by lighting an LED, or by sound such as voice or buzzer.

If it is determined that the label R is not being discarded (S803: NO), the CPU 41 returns the processing to S801.

As described above, the CPU 41 accepts a second print instruction related to the reprinting of the 21st label R in continuous printing. When the CPU 41 accepts the second print instruction for reprinting the 21st label R, it sequentially prints the labels R from the 21st onward. The label affixing apparatus 1 contributes to enabling the user to easily recognize the printing order of the labels R related to the reprinting. Therefore, the label affixing apparatus 1 facilitates smooth wrapping of the labels R onto the cable 19 by the user.

The label R is adhered to release paper Rp. The peeling part 4 is positioned downstream of the label R conveyance path relative to the printing unit 3. The peeling part 4 bends the release paper Rp to separate the label R from the release paper Rp. The take-up unit 8 is capable of taking-up either the release paper Rp from which the label R has been peeled at the peeling part 4 or the release paper Rp with the label R remaining adhered without being peeled at the peeling part 4. When the CPU 41 receives a second print instruction, it drives the take-up unit 8 with a first take-up force to take-up the release paper Rp with the label R still adhered and not peeled at the peeling part 4. The label affixing apparatus 1 contributes to taking-up the release paper Rp without peeling the label R from the release paper Rp by driving the take-up unit 8 with the first take-up force.

The first take-up force is less than the reference take-up force of the take-up unit 8. Since the label affixing apparatus 1 drives the take-up unit 8 with the first take-up force less than the reference take-up force, it more reliably contributes to taking-up the label R without peeled from the release paper Rp.

The CPU 41 drives the take-up unit 8 with a second take-up force greater than the first take-up force when the Nth label R based on the second print instruction reaches the peeling part 4, thereby taking-up the release paper Rp from which the label R has been peeled off at the peeling part 4. By driving the take-up unit 8 with the second take-up force, the label affixing apparatus 1 contributes to applying a force that causes the label R to be peeled off from the peeling portion 4.

The second take-up force is greater than the reference take-up force of the take-up unit 8. Since the label affixing apparatus 1 drives the take-up unit 8 with the second take-up force, which is greater than the reference take-up force, it contributes to more reliably peeling the label R from the release paper Rp.

The label R is adhered to the release paper Rp. The cutting unit 9 is positioned downstream of the printing unit 3 along the conveyance path of the label R. The cutting unit 9 cuts the label R, on which printing by the printing unit 3 has been completed, leaving the release paper Rp uncut and continuous. The CPU 41 does not execute cutting by the cutting unit 9 from the time the second print instruction is received until the Nth label R corresponding to the second print instruction reaches the cutting unit 9. Since the label affixing apparatus 1 does not cut the label R with the cutting unit 9, it contributes to suppressing the possibility that the label R is peeled off from the release paper Rp at the peeling part 4.

The peeling part 4 is arranged downstream of the label R transport path relative to the printing unit 3. The peeling part 4 peels the label R, which has been printed by the printing unit 3, from the release paper Rp. The take-up unit 8 is to take-up the release paper Rp from which the label R has been peeled by the peeling part 4, or the release paper Rp with the label R still adhered thereto. Upon receiving a second print instruction, the CPU 41 causes the take-up unit 8 to take-up the release paper Rp with the label R still adhered thereto without being peeled by the peeling part 4. The CPU 41 notifies that the take-up unit 8 is currently taking-up the release paper Rp with the label R still adhered thereto, i.e., without being peeled by the peeling unit 4. The label affixing apparatus 1 contributes to enabling the user to recognize that the label R is currently being taken-up for disposal.

In the description of the above modified example, the label R with N=21 is an example of the "N-th label" of the present invention. The process S603 is an example of the "take-up the release paper with a first take-up force" of the present invention. The process S613 is an example of the "take-up the release paper with a second take-up force" of the present invention. The processes S603 and S609 are examples of the " take-up the release paper with a third take-up force" of the present invention. The process S805 is an example of the "notification process" of the present invention.

The technical elements disclosed in the specification or drawings can exhibit technical utility either individually or in combination. The technologies exemplified in the specification or drawings are capable of achieving multiple objectives simultaneously, and even achieving a single one of these objectives confers technical utility.

The present invention is not limited to the specific combinations recited in the claims as filed. Even if certain claims are described as dependent on only some claims in the original filing, this does not preclude the possibility of them depending on other claims. The applicant intends to obtain patent rights for combinations not explicitly stated in the claims as filed, provided such combinations fall within the scope of the invention disclosed in the specification and are not technically contradictory.

What is claimed is:

1. A label affixing apparatus comprising:
a printing unit;
a wrapping unit; and
a control unit that controls the printing unit and the wrapping unit,
wherein the control unit executes:
a first reception process for receiving a first print instruction related to continuous printing,
a printing process for printing, by the printing unit, a print image on a label in accordance with the first print instruction,
a wrapping process for wrapping a printed label onto a rod-shaped member, using the wrapping unit, and
a second reception process for receiving a second print instruction for reprinting, and
wherein the printing process includes a first process for printing a print image on a label in accordance with the second print instruction.

2. The label affixing apparatus according to claim 1, wherein
the second print instruction is received during the continuous printing, and
the printing process includes a second process for printing a print image in accordance with the first print instruction on a label after the first process for printing in accordance with the second print instruction.

3. The label affixing apparatus according to claim 1, further comprising a conveying unit,
wherein
the wrapping unit includes an insertion part, and a rotating member configured to rotate a rod-shaped member inserted through the insertion part,
the control unit controls the conveying unit to transport the label to a stop position and notifies that the label reaches the stop position.

4. The label affixing apparatus according to claim 3, further comprising a light-emitting unit;
wherein
the second print instruction includes instructions for reprinting Nth label of the continuous printing,
the print image of the first process is a print image for the Nth label, and
the control unit controls the light-emitting unit to blink N times for notification.

5. The label affixing apparatus according to claim 1, further comprises an operation unit for inputting the second print instruction.

6. The label affixing apparatus according to claim 3, further comprising a sensor,
wherein
when the sensor does not detect the rod-shaped member is at a particular position, the second print instruction is received, and
when the sensor detects the rod-shaped member is at a particular position, the wrapping unit wraps a label onto the rod-shaped member.

7. The label affixing apparatus according to claim 1,
wherein, before completing printing in accordance with the first print instruction, a print image is printed in accordance with the second print instruction.

8. The label affixing apparatus according to claim 2,
wherein, after receiving the second print instruction, a particular number of labels are made in accordance with the first print instruction before printing in accordance with the second print instruction.

9. The label affixing apparatus according to claim 8,
wherein the control unit further executes setting the particular number.

10. The label affixing apparatus according to claim 1,
wherein
the second print instruction includes instructions for reprinting Nth label of the continuous printing, and
the Nth and subsequent labels are printed upon receiving the second print instructions.

11. The label affixing apparatus according to claim 10, further comprising:
a peeling part located downstream of the printing unit in a direction of transporting the label; and
a take-up unit,
wherein
the label is adhered to a release paper,
the take-up unit is configured to take-up the release paper, and
the control unit controls the take-up unit to take-up the release paper with a first take-up force when receiving the second print instruction.

12. The label affixing apparatus according to claim 11, wherein the first take-up force is less than a reference take-up force, the reference take-up force being equivalent to an adhesive force of the label adhered to the release paper.

13. The label affixing apparatus according to claim 11, wherein the control unit controls the take-up unit to take-up the release paper with a second take-up force greater than the first take-up force when the Nth label is at the peeling part.

14. The label affixing apparatus according to claim 13, wherein the second take-up force is greater than a reference take-up force, the reference take-up force being equivalent to an adhesive force of the label adhered to the release paper.

15. The label affixing apparatus according to claim 10, further comprising:
a cutting unit located downstream of the printing unit in a direction of transporting the label,
wherein the control unit does not cause the cutting unit to operate until the Nth label reaches the cutting unit.

16. The label affixing apparatus according to claim 10, further comprising:
a peeling part located downstream of the printing unit in a direction of transporting the label; and
a take-up unit,
wherein, upon receiving the second print instruction, the control unit executes notification to notify that the take-up part is operating.

17. A method for making a label using an apparatus that includes a printing unit, and a wrapping unit, the method comprising:
receiving a first print instruction related to continuous printing;
printing, by the printing unit, a print image on a label in accordance with the first print instruction;
wrapping a printed label onto a rod-shaped member, using the wrapping unit;
receiving a second print instruction for reprinting; and
printing a print image on a label in accordance with the second print instruction.
